(19) United States
(12) Patent Application Publication
(10) Pub. No.: US 2016/0200551 A1
(43) Pub. Date: Jul. 14, 2016

(54) SPACE ELEVATOR ASSEMBLY

(71) Applicant: Nofel Izz, Mississauga (CA)

(72) Inventor: Nofel Izz, Mississauga (CA)

(21) Appl. No.: 14/592,403

(22) Filed: Jan. 8, 2015

(51) Int. Cl. B66B 9/02

(52) U.S. Cl. CPC B66B 9/02

(57) ABSTRACT

The present invention relates to a space elevator assembly, comprising an inner shaft comprising a plurality of interlocking segments, wherein each segment further consist of cylindrical bits vertically stackable on a rigid plate to form a rigid structure and an outer shaft comprising a plurality of telescoping cones extendable synchronously with the inner shaft, in order to elevate a platform attached to an upper end. The assembly further comprises a drive system consisting of an actuator for extending the inner shaft by enabling stacking the plurality of interlocking segments.

### CROSS-REFERENCE TO RELATED APPLICATION

This application claims benefit of priority of U.S. Application 61/925,372 filed on Jan. 9, 2014 entitled “Space Elevator” owned by the assignee of the present application and herein incorporated by reference in its entirety.

### FIELD OF THE INVENTION

The present invention generally relates to a space elevator for transporting payload, goods and people from earth's surface to outer space, and more particularly relates to a space elevator assembly supported from its base grounded on earth's surface.

### BACKGROUND OF THE INVENTION

The key concept of space elevator was first published in 1895 by Konstantin Tsiolkovsky, who proposed a free-standing tower reaching from the surface of Earth to the height of geostationary orbit. Similar to high-altitude buildings and towers, Tsiolkovsky's structure was under compression, supporting the tower's own weight from below. However, since 1959, most ideas for space elevators have focused on tethering using purely tensile structures, with the weight of the elevator system being held up from above. A space tether reaches from a large mass or a counterweight stationed beyond geostationary orbit to a base support anchored on the ground. This structure is held in tension between Earth and the counterweight like an upside-down plumb bob.

Earth-based space elevator would typically consist of a cable with one end attached to the surface near the equator and the other end in space beyond geostationary orbit. The competing forces of gravity, which is stronger at the lower end, and the upward centrifugal force, which is stronger at the upper end, would result in the cable being held up under tension, and stationary over a single position on Earth.

Once the space elevator is installed, climbing devices will clamp on to the tether and will be driven up or down the tether to deliver a payload to a desired altitude using a driving means such as electric or mechanical drive. Space elevators have also sometimes been referred to as beanstalks, space bridges, space lifts, space ladders, skyhooks, orbital towers, and orbital elevators.

Current space transport and launch systems, with the advent of chemical rockets and improved guidance systems facilitates in overcoming the primary technical inability to transport materials and payload from the surface of the earth to the outer space. However, factors including huge costs, propellant energy resources, and safety during launch, still prevails as major concerns. In addition, the need for, countering gravity during flight, overcoming atmospheric drag and robust propulsion system poses further limitations to the existing rocket systems.

Since 1971, NASA has launched 135 missions, with each mission costing approximately $1.3 billion. Rockets have been an expensive undertaking and unlike any other mode of transportation, a rocket has a 40% vehicular failure rate and 1.5% flight failure rate.

Throughout the years there have been concepts of a space tether made of carbon nanotubes while sending a counterweight far beyond the geostationary orbit. Although the nanotubes technology is still in its infancy, it would require cables with widths of several miles to reach heights of 144,000 kilometers (89,000 miles) into space for a counter weight, the cost of which would be enormous.

U.S. Pat. No. 6,491,258 discloses transporting payload via cable between two docking means positioned at different orbital distance from Earth surface. US patent publication 20100163683 relates to a segmented space elevator tower comprising pneumatically pressurized cells. US patent publication 20080099624 relates to a space tether transport system for transporting payloads between points on the ground, in the air, and in outer space.

Therefore, there still exist a need for an improved space elevator system, which can be used for transporting payload, materials and people from earth's surface to outer space or planetary surface.

### SUMMARY OF THE INVENTION

The present invention relates to a space elevator assembly supported from a base grounded on surface of the earth, the space elevator can be used for transporting payload, goods and people from earth's surface to outer space.

The space elevator assembly of the present invention comprises an inner shaft comprising a plurality of interlocking segments composed of cylindrical bits vertically stackable to a plate, to form a rigid structure and an outer shaft comprising a plurality of telescoping cones extendable synchronously with the inner shaft, in order to elevate a platform attached to an upper end. The space elevator assembly further comprises a drive system consisting of an actuator for extending the inner shaft by enabling stacking of the plurality of interlocking segments.

In an embodiment, the inner shaft comprises a plurality of interlocking segments, wherein the each interlocking segment comprises a combination of cylindrical bits stackable on a rigid plate, which interlocks the bits in place and also prevents buckling effect during extended position. The number of bits per interlocking segment progressively increase during extension of the inner shaft from the base.

### BRIEF DESCRIPTION OF DRAWINGS

FIG. 1 illustrates a perspective view of the space elevator assembly according to an embodiment of the present invention.

FIG. 2 illustrates a sectional view of the outer shaft according to an embodiment of the present invention.

FIG. 3 illustrates a base frame with stay cables attached to a support rail according to an embodiment of the present invention.

FIG. 4 illustrates a sectional view of the outer shaft comprising the inner shaft in a vertically stacked position.

FIG. 5A-5C shows interlocking segments of the inner shaft.

FIGS. 6-15 schematically illustrates exemplary lift stages for extension of inner shaft in conjunction with outer shaft.

FIG. 6 illustrates lift stage one during extension of inner shaft in conjunction with outer shaft.

FIG. 7 illustrates lift stage two during extension of inner shaft in conjunction with outer shaft.

FIG. 8 illustrates lift stage three during extension of inner shaft in conjunction with outer shaft.

FIG. 9 illustrates lift stage four during extension of inner shaft in conjunction with outer shaft.

FIG. 10 illustrates lift stage five during extension of inner shaft in conjunction with outer shaft.

FIG. 11 illustrates lift stage six during extension of inner shaft in conjunction with outer shaft.

FIG. 12 illustrates lift stage seven during extension of inner shaft in conjunction with outer shaft.

FIG. 13 illustrates lift stage eight during extension of inner shaft in conjunction with outer shaft.

FIG. 14 illustrates lift stage nine during extension of inner shaft in conjunction with outer shaft.

FIG. 15 illustrates lift stage ten during extension of inner shaft in conjunction with outer shaft.

FIG. 16 shows an image illustrating self-weight of bottom cones.

FIG. 17 illustrates a shows a seismic hazard map.

FIG. 18 shows a model of dynamic earthquake testing.

FIG. 19 illustrates modeling of earthquake force on the X direction using Etabs software.

FIG. 20 illustrates ETABS Building model for natural period.

FIG. 21 illustrates a graph showing change in shear forces with number of lift stages.

FIG. 22 illustrates distribution of seismic lateral forces.

FIG. 23 shows non-cumulative distribution of seismic forces.

FIG. 24A shows the latitude angle of rotation of object from earth's centre of matter.

FIG. 24B shows a graph of gravity force in relation to centripetal force and component force.

FIG. 25A-25L shows images of finite element method modelling of the tower structure using ETABS software.

FIG. 26A-26E shows a second model of the tower structure at different elevations.

FIG. 27A illustrates axial forces in the lowest cone.

FIG. 27B shows bending moment in the lowest cone during simulation of a minor earthquake.

FIG. 27C shows axial force in one of the bits at the bottom of the tower structure.

FIG. 28 illustrates distance calculation for tower axis from the point of cable ground support.

FIG. 29A shows cable supporting the tower structure until 6^{th} storey or level.

FIG. 29B shows seismic deformation of the tower structure.

FIG. 29C shows moment diagram in the tower structure.

FIG. 30 illustrates deformation due to bending moment in the tower structure.

FIG. 31A illustrates Columns made by interlinked bits.

FIG. 31B. Shows deformation due to buckling and internal forces appear in the connection between bits.

FIG. 31C and FIG. 31D illustrates anchors expending from the bit core in to the bit notch.

FIG. 32 shows force distribution in the joint between bits.

FIG. 33A and FIG. 33B shows extra lateral anti-buckling support provided by the columns joined to the cons.

FIG. 34 shows connection between supporting bits.

FIG. 35 shows buckling stability from both anti-buckling support and connection between supporting bits.

FIG. 36 shows an interlocking segment comprising cylindrical bits interlocked in position by a rigid plate.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

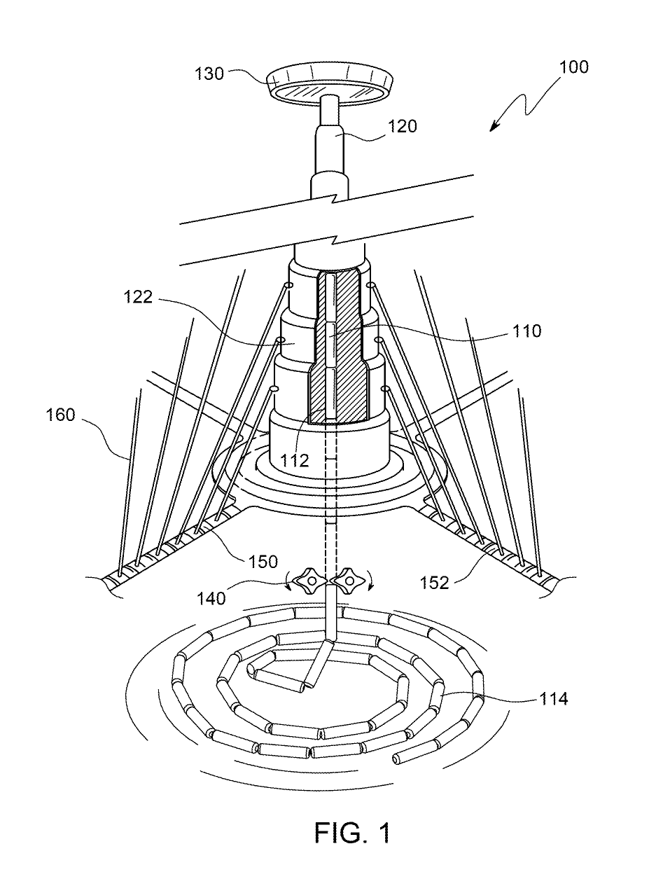

Referring to FIG. 1, which shows a space elevator assembly 100, comprising an inner shaft 110 comprising a plurality of interlocking segments 112 consisting of cylindrical bits vertically stackable on a rigid plate in order to extend into a tower like structure. An outer shaft 120 comprising a plurality of telescoping cones 122 extendable synchronously with the inner shaft 110, in order to elevate a platform 130 which is attached to an upper end of the inner shaft 110 and outer shaft 120. The space elevator assembly 100 further comprises a drive system consisting of an actuator 140 for extending the inner shaft 110 by enabling stacking of the plurality of interlocking segments 112 from a winded position.

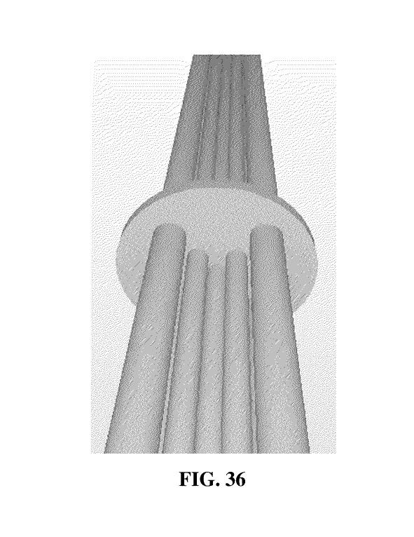

Each interlocking segment comprising a plurality of cylindrical bits stackable on a rigid plate as shown in FIG. 36. The number of bits progressively increase in numbers for each segment during extension. The rigid plate helps to hold the bits in interlocked position after extension and prevents buckling effect, which is described further in later part of this specification.

The space elevator assembly 100, further comprises a base frame structure 150 comprising a plurality of stay cables 160 for supporting the outer shaft 120 in an extended position. More particularly, the stay cables 160 are adapted to support not all but some successive telescoping cones 122 from the bottom. The rest of the top telescoping cones 122 do not require the support of the stay cables 160. The stay cables 160 are winded on a stay cable support rail 152 of the base frame structure 150 in a retreated position wherein, the stay cables 160 are extended as the outer shaft is upwardly extended.

In an embodiment, interlocking segments 112 are winded on a spool in the retreated coiled position 114 and stacked to form a vertically rigid shaft in the extended position. The spool can be positioned above ground or underground in a coiled structure, providing access to the drive system comprising an actuator 140 to enable extending of inner shaft 110 by stacking of numerous interlocking units during different stages of extension. The actuator 140 is driven by a controllable motor comprising electrical engine or a mechanical or hydraulic driving means. The actuator 140 uploads the bits or interlocking units 112 and locks them and then it unloads them and unlocks them to be stored in any position such as stored vertically or coiled up once again.

In an embodiment, the interlocking segments 112 of inner shaft comprises a plurality of bits which are unlocked and stacked to form a rigid inner shaft during extension from a winded position. The number of bits for each telescoping cone substantially increases with vertical extension of telescoping cones. For example during 1st expand: first extended cone comprises 1 bit; 2^{nd} expand: second extended cone comprises 2 bits; 3^{rd} expand: third extended cone comprises 3 bits. The bits can be stacked in different combinations during further extension of telescoping cones, as exemplified above.

The platform 130 at the upper end is supported by the inner shaft 110 and outer shaft 120 extending from the ground, the platform allows payloads or materials or people to be elevated to outer space or earth orbit or any level of elevation lower than the geostationary orbit. In an embodiment, the top platform weighs 5 tons and comprises 2500 square meter area.

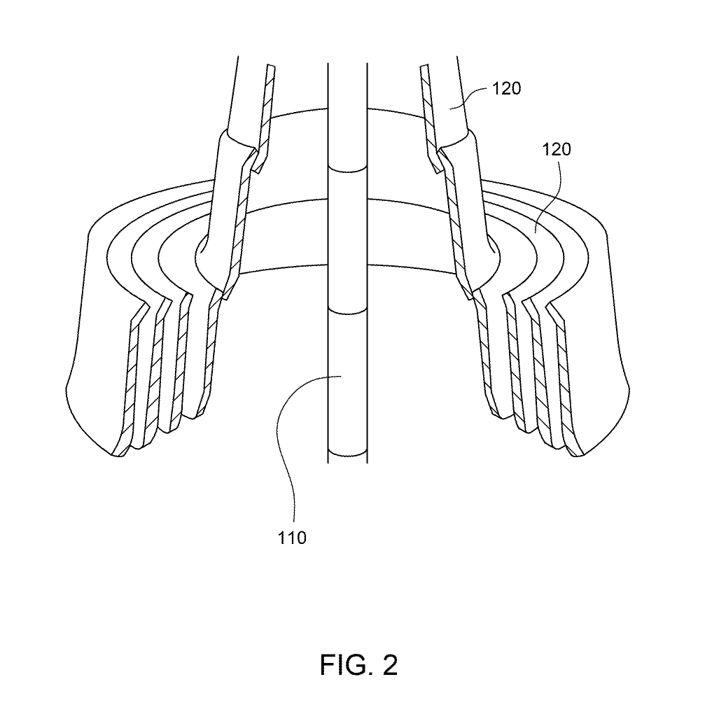

FIG. 2 illustrates a sectional view of the outer shaft according to an embodiment of the present invention. The outer shaft 120 comprises a plurality of telescoping cones 122, also known as telescopic exo shell constructed with cylindrical cones of progressively decreasing diameters, with the outermost cone having a greater diameter and the inner most cone at the core having a lowest diameter. The telescoping cones 122 are configured to extend to a predetermined height and are made of atmospheric drag resistant material, which confers greater stability to the overall structure.

The inner shaft 110 forms a rigid structure due to vertically stacking of interlocking segments. The outer shaft provides exoskeletal support by extending synchronously with the inner shaft in order to elevate the platform fixed at the upper end of the shafts. Similarly, the outer shaft comprising telescoping cones retreats synchronously along with the inner shaft.

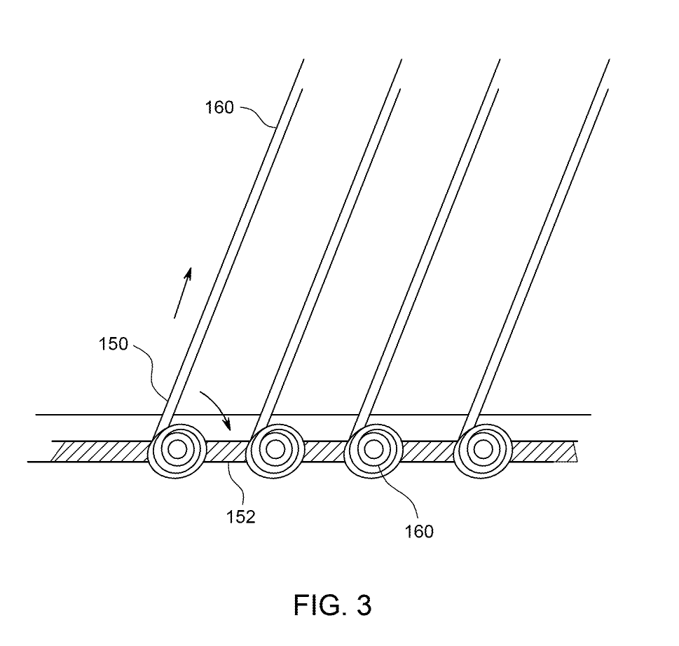

FIG. 3 illustrates a base frame with stay cables attached to a support rail according to an embodiment of the present invention. The base frame 150 comprises a star-like or cross-like platform which supports the vertical tower structure and comprises a plurality of stay cables 160 with one end attached to first few cones of the outer shaft and other end of the stay cable attached to a stay cable support rail structure 152.The stay cables 160 can be winded in a direction 104 during retreat and unwounded in a direction 102 during extension.

The stay cables 160 support the outer shaft and provides stability while in synchronously rotation towards or away from the overall vertical structure as required. The stay cables 160 can be independently coiled as an individual unit into a winded position or are supported autonomously by an overall coiling and uncoiling system for all the cables to work synchronously within the stay cable support rail 152.

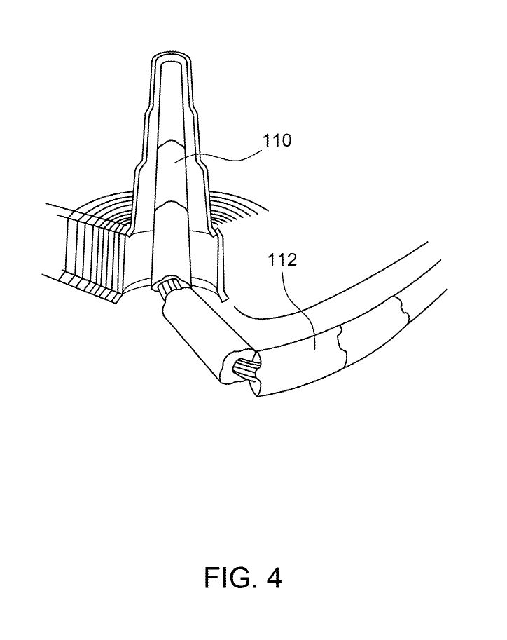

FIG. 4 illustrates a sectional view of the outer shaft comprising the inner shaft with interlocking segments in a vertically stacked position. The outer shaft comprises telescoping cones in an extended position, which supports the inner shaft 110 consisting of interlocking units 112 stacked to form a vertical rigid structure.

The inner shaft 110, when uncoiled from the spool, extends by stacking of interlocking segments 112 and provides lift to the space elevators by extending the overall vertical structure towards any elevation including lower Earth orbit or beyond geostationary orbit. Similarly the interlocking segments 112 are un-stacked and coiled during descending.

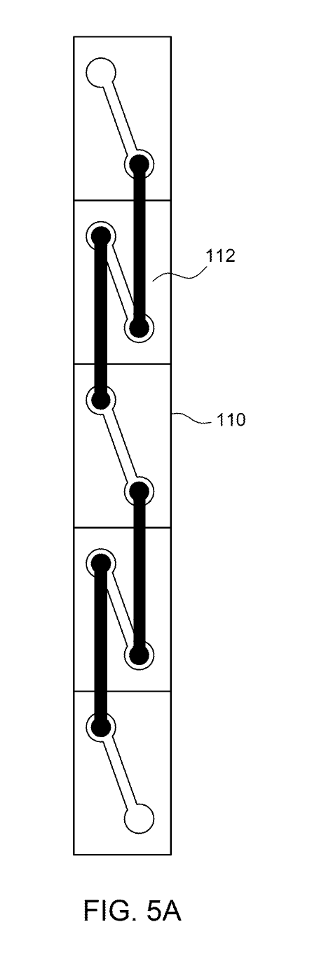

FIG. 5A shows interlocking segments 112 vertically stacked above each other to form a rigid inner shaft 110. FIG. 5B and FIG. 5C respectively shows stacking and un-stacking of interlocking segments of inner shaft.

In an embodiment, the base size would be 50% of the overall height. For example, if the structure extends up to 99 miles or 160 km, then it would be required that the base size should be half of that distance, approximately 49.5 miles or 80 km.

The space elevator would be constructed using super strong and lightweight metal alloys that would provide the structure immense strength-to-weight ratio. It would be constructed using materials such as Titanium alloys that are currently being used by the aviation industry.

The inner shaft is constructed from a material with an ultimate bearing strength preferably in the range of 170,000 to 200,000 PSI. Materials for manufacturing inner shaft can be selected from a group consisting of Titanium, Kevlar or other strong but relatively lightweight materials. In an embodiment, Titanium alloy Ti-10V-2Fe-3Al is used. Ti-10V-2Fe-3Al is a fully beta Titanium base alloy, which is harder and stronger than many Titanium alloys. It is a heat-treatable alloy, wieldable, easily formable and commonly used in compressor blades, airframe components, disks, wheels and spacers.

Ti 10V-2Fe-3Al being an all beta alloy, it is more difficult to machine than most of the Titanium alloys. The following Table. 1 shows structural properties of Titanium alloy Ti-10V-2Fe-3Al.

TABLE 1

| Compressive yield strength (fyc) | 1200 | Mpa |
|---|---|---|
| Ultimate Bearing Strength (fuc) | 1700 | Mpa |
| Compressive Yield Strength (fyc) | 1080 | Mpa |
| Ultimate Bearing Strength (fuc) | 1530 | Mpa |
| Modulus of Elasticity (E) | 107 | Gpa |
| Elongation at Break (εu) | 10% | |
| Specific Weight (γ) | 45.6 | kN/m³ |

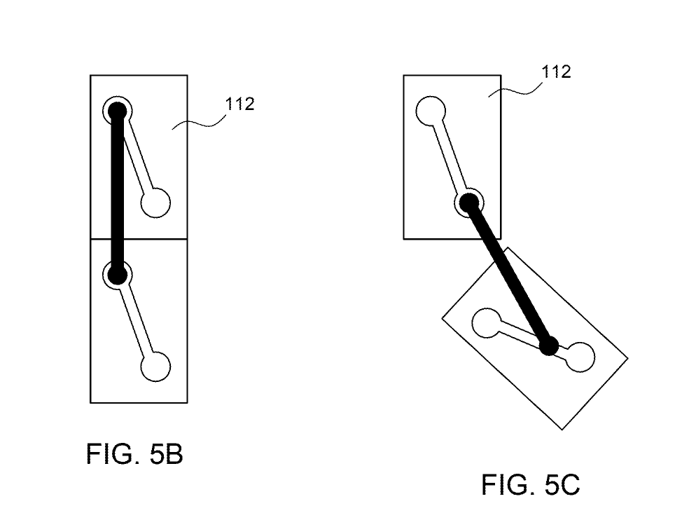

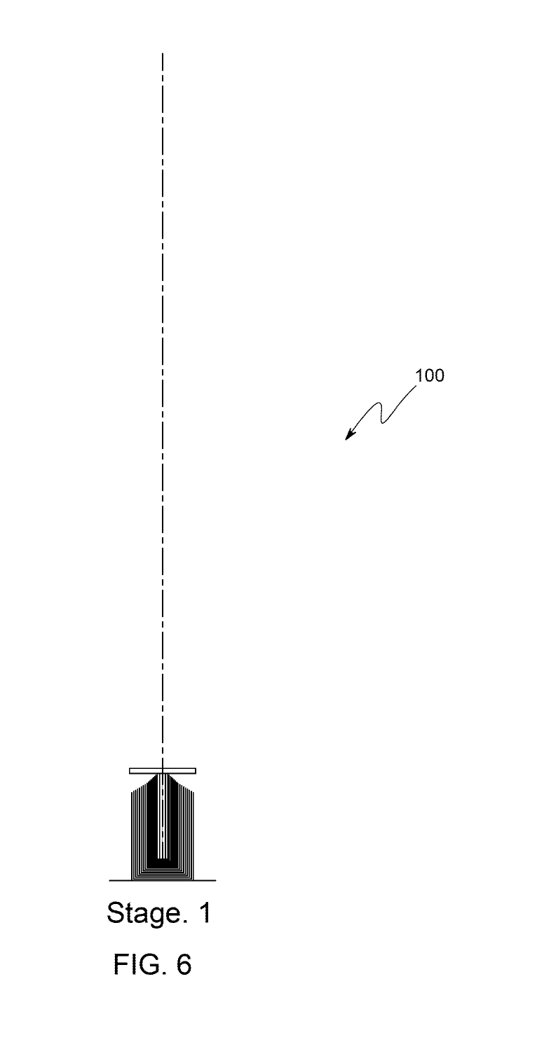

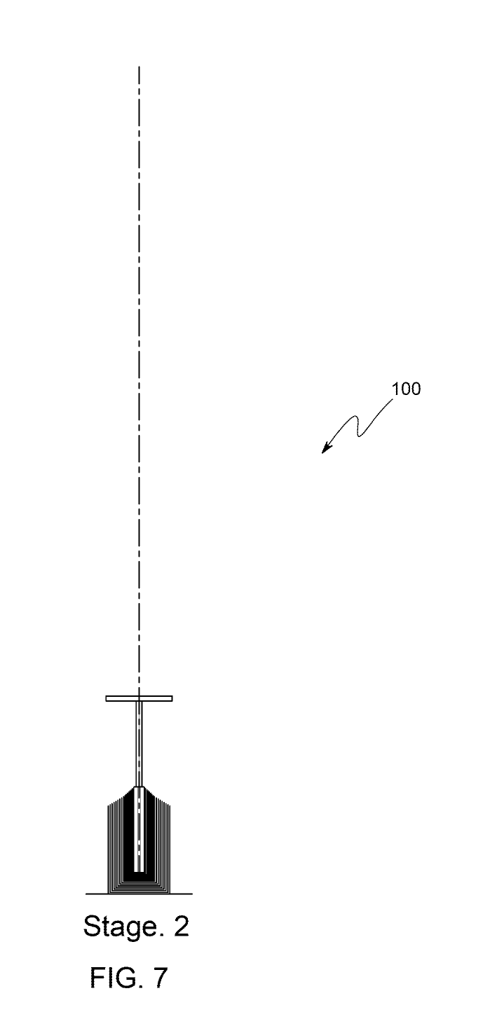

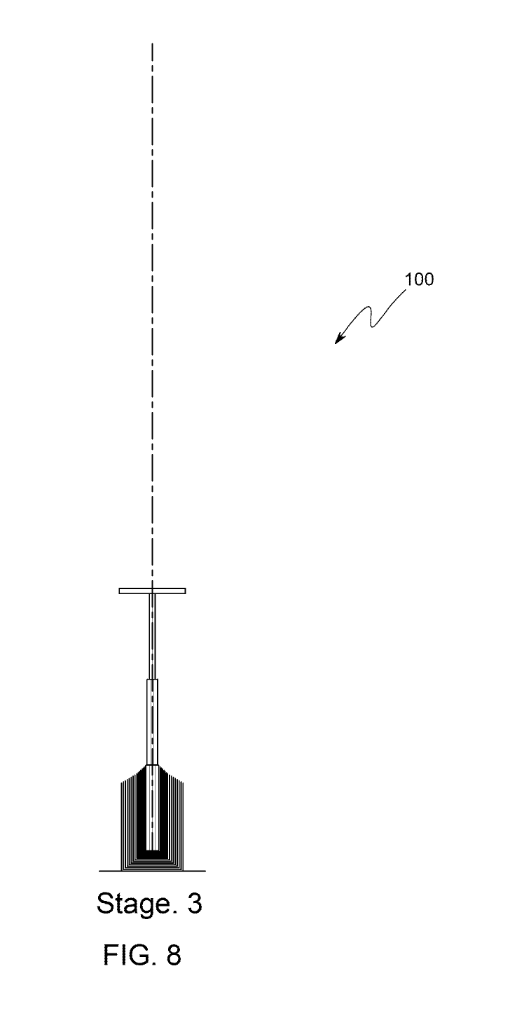

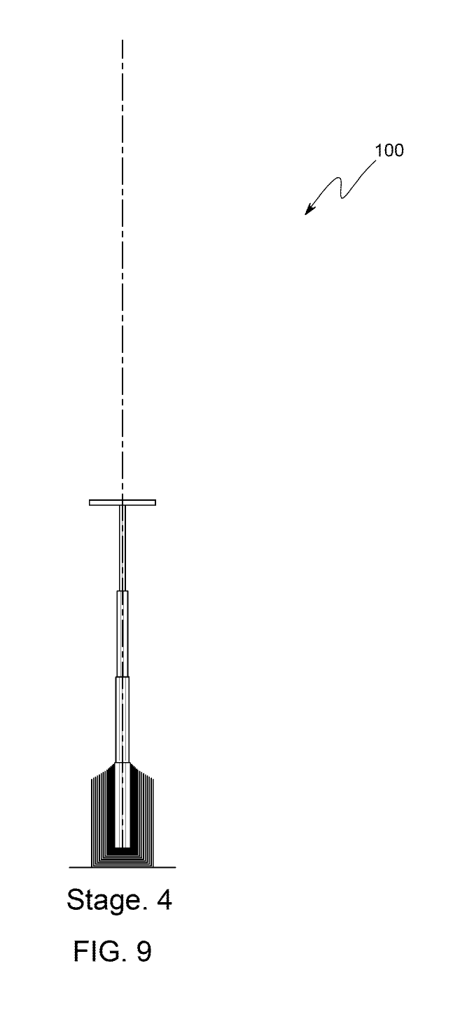

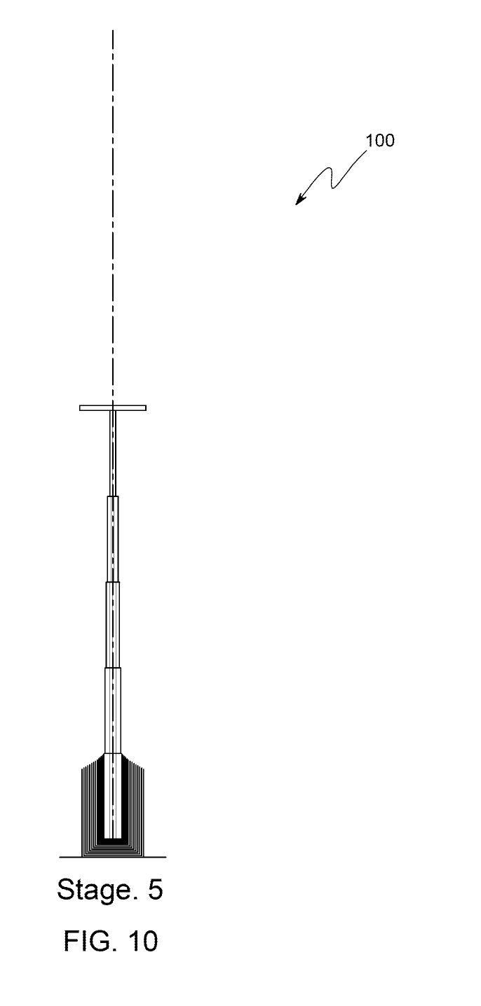

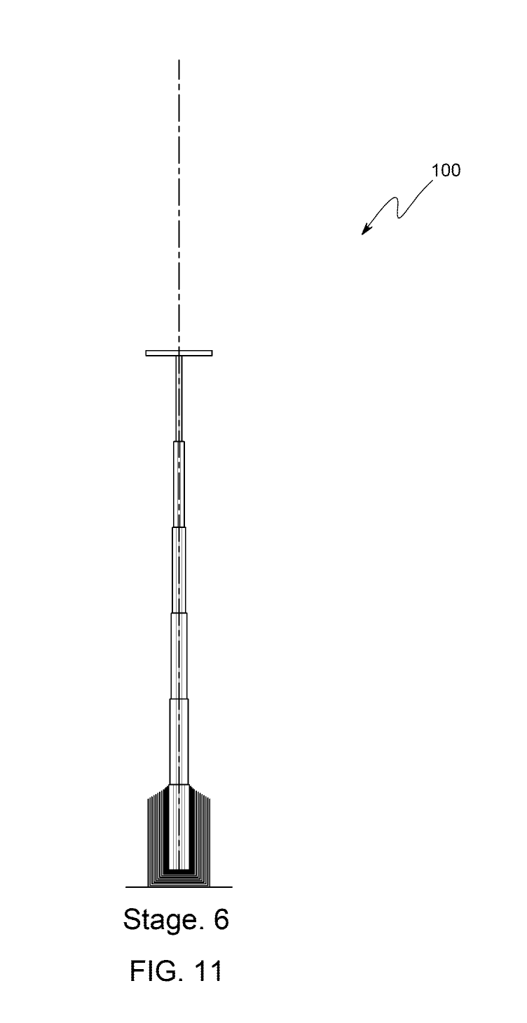

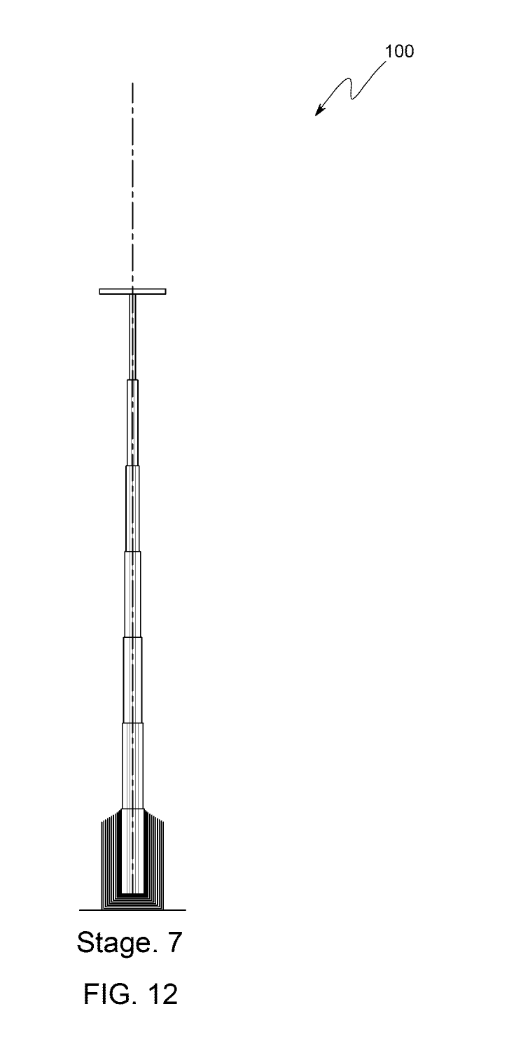

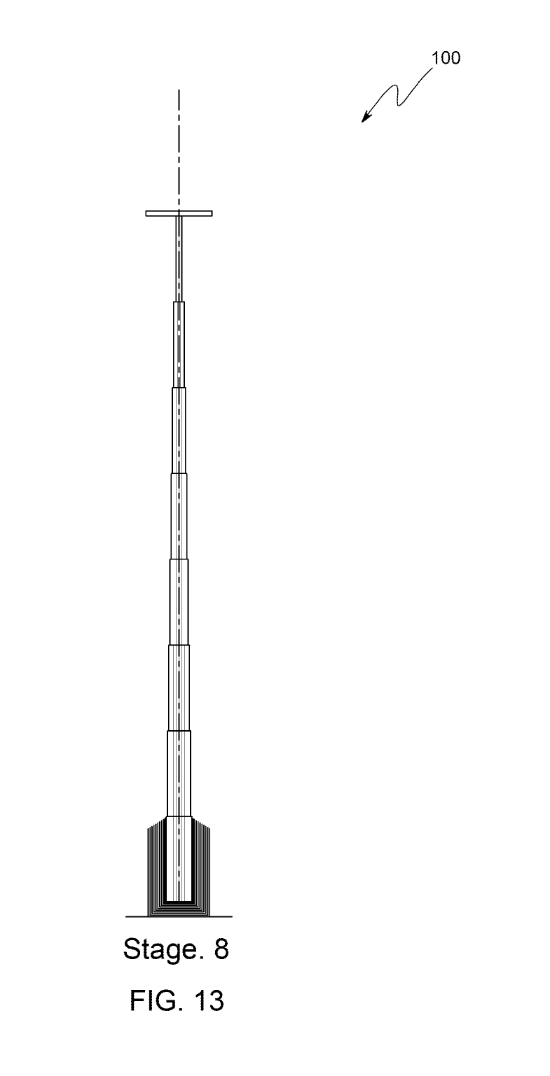

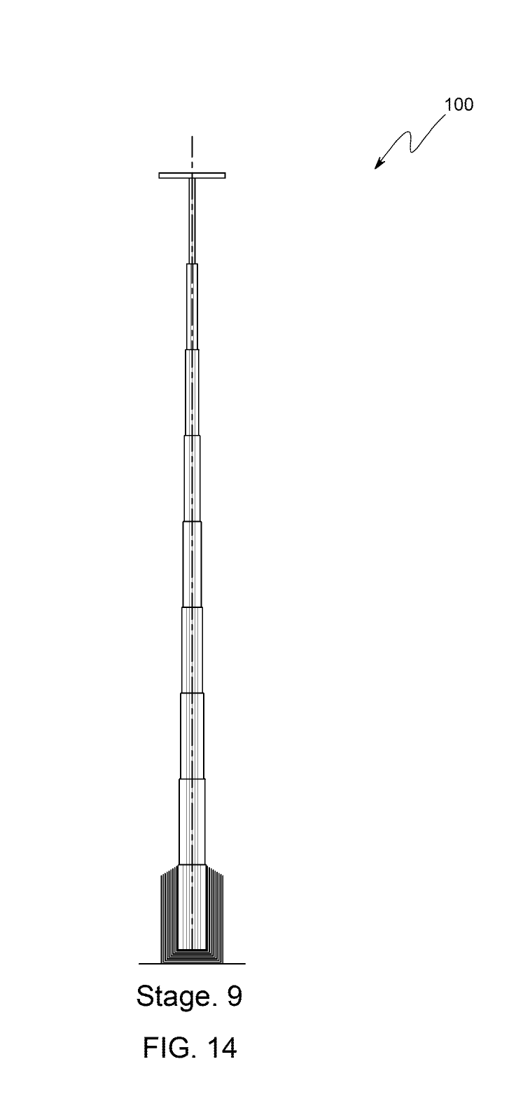

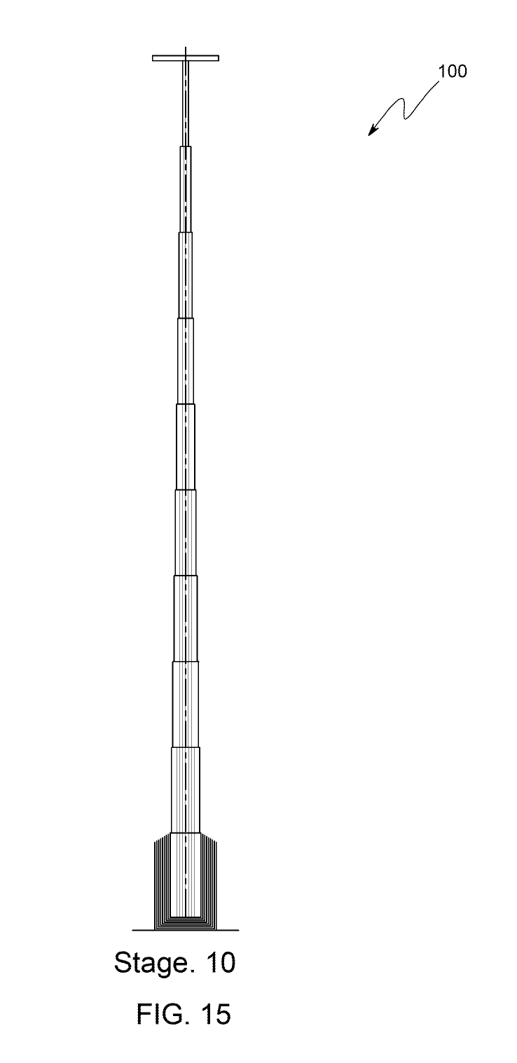

In another embodiment the inner shaft comprises of plurality of cylindrical bits or columns adapted to extend in progressive combinations according to height. The bits synchronously extend with outer shaft comprising telescoping cones, in progressive expand stages or lift stages during vertical extension. FIGS. 6-15 schematically illustrates exemplary lift stages 1-10 showing progressive increase in the number of bits during extension of inner shaft in conjunction with telescoping cones.

Structural system: The main structural system has to be designed to carry the biggest load that is the self-weight of the system. The tower extension basically comprises of two steps: 1. Uplifting—during which the column takes the weight of the cones too; and 2. Fully expended locked structure—during which the columns will not take the weight of the cones.

Determining the height of the columns:

### Exemplary Calculations

Having only the axial force (compression or tension doesn't matter), the axial stress, called sigma “σ” will be equal to:

$$σ = \frac{N}{A} \qquad [ 1 ]$$

Where, N—axial force and A—the cross section area
   But when considering only the axial force from self-weight, the N will be:

N=γ*V[2]
Where, V—is the volume [meter cube] and the γ—specific weight
   The Volume will be:

V=A*L[3]
Where, A—cross section area and L—length
   Now substituting [3] in [2]:

N=γ*A*L[2′]

### Substituting [2′] in [1]:

$$σ = \frac{γ * A * L}{A} γ * L \qquad [ {1}^{′} ]$$

And now, the ‘A’ will simplify and this is the formula for stress, when considering only self-weight.

To find the maximum length, from the [1′] equation:

L=σ/γ[4]

Using the formula σ=γ*L, with known strength limit γ and weight factor L, Where σ is equal to “fy”=material tension design value, which is the ultimate tensile strength, the limit state design is assumed as 1500*1000. The maximum height of 1 bit can be calculated as:

L=σ/γ=(1500*1000)/(45.6)=about 30000 m=30 km

In certain circumstances the maximum height of one bit for the inner shaft would be required to be 30 km in height in order to sustain its own weight. But the axial forces will have the Cones weight too and the top load.

Ultimate strength only from the axial force would mean that the tower would reach the strength capacity when ascending and would need to split the tower into 20 pieces for the length of 160 km:

Height of 1bit=(160 km)/20=8 km=8000 m for every bit

With this above calculated length, the stress from self-weight can be calculated as:

σ=45.6* 8000=364800 kN/m2=364.8 N/mm2

Wherein 364. 8 N/mm2 is 22% of its capacity from self-weight, 1600*0.22=352, so about 364.

As mentioned above, the tower extension basically comprises of two steps: 1. Uplifting—during which the column takes the weight of the cones too; and 2. Fully expended locked structure—during which the columns will not take the weight of the cones. When the tower is fully expended and locked in, the telescoping cones and bits will carry the weight but during lifting process, the weight will have to be carried only by the bits, hence the bits are designed at full axial force.

The tower is being split into 20 parts, each part is calculated to sustain itself from the weight of other parts above it. Between the parts, a rigid plate is placed to form a support for bits and cones, and interlocked or glued to create a rigid joint.

Design of bits: In an embodiment, the cross-sectional shape of the bit is circular. The area of circle can be calculated as:
Area of the circle (A)=PI*D̂2/4
Choose the diameter (D)=55000 [mm] or 55 [m]
Area (A)=2.4E+09 [mm²] or 2375.8 [m^{2]}
Volume=Area*height
=2.4*10̂9 mm square*8000*1000 mm
=1.92*10̂16 mm cube
=19200000 meter cube
   Self-weight of bits:
Self-weight is represented as Nself=volume*specific weight
The specific weight for Titanium is 45.6 kN/m cube
Hence, Nself=19200000 m̂3*45.6 kN/m̂3
=866702581.3 [kN]
   Compression force:
The stress from axial force σ=N/A
Height of the cone: 8000 [m]
For the maximum length of 160 km, the self-weight will be:
From the top platform 5 tones=50 kN
Nself=866702581.3 [kN]
Ntop plat=50 [kN]
Since σ=N self/Area
For 1.5 stress SUM: N₁=866702631.3 [kN]
Hence, the stress is calculated as: σ=N/A
=866702631.3/2375.8
=364.8 [MPa]
The rate of actual stress/allowable stress (design stress for um)=σ/fyc
=364.8/1080
=0.3378

CONE Material Properties:
Specific weight γ=45.6 [kN/m3]
Exemplary dimensions of CONE are given in the following Table. 2.

TABLE 2

| | | |
|---|---|---|
| Thickness (t) | 10000 | [mm] |
| Height (H) | 7000 | [m] |
| Outside diameter D′ | 68000 | [mm] |
| Volume of the cones (V) | 12754866.2 | [mc] |

Here volume is Area*Height
Area=πR̂2-πr̂2
=π(34̂2-29̂2)
=1980 m̂2
Hence V=area*height
=1980*7000
V=13860000 m̂3
Self-weight is represented as Nself=volume*specific weight
Nself=13860000 m̂3*45.6 kN/m̂3
Thus, the self-weight of the cone is calculated as, Ncone=632016000[kN]

Total weight for the cone:

For example, during lift stage 1, there will be only one column and there is no axial force exerted from the above columns. Whereas from lift stage 2, axial force from first column will have to be added. Similarly during lift stage 5, there will be more columns (5 columns), the axial force calculated from weight of the cone and the whole weight from above columns should be split by the number of column, i. e. divided by 5 in this case.
So the stress will be: σ=Ncone/Area
=632016000*10̂3 N/(1980*10̂6 mm̂2)
=319.1 Mpa, which is the stress from weight of the cone.

The total stress in the cone can be calculated using:
1. Adding the two axial forces for finding σ.
2. Finding a from self-weight (weight of the column) and then find a from the weight of the cone and then adding both the stress to calculate total stress as shown below:
When the tower is uplifting, the weight of the cone will also be supported by the bits, so for a predesign dimension of the bits, the stress from the cone is added.
Total Stress=stress from the self-weight+Stress from the Bit's Weight
=319.1 Mpa+364.8 Mpa
=683.9 Mpa
The rate actual stress/allowable stress (design stress for Titanium): σ/fyc
=683.9/1080
=0.63324

The axial force for different levels of the vertical tower during each stage of extension is given in the following Table. 3, where
D=the diameter of the cone,
V=volume of the cone,
Ncon=the axial force given by the cone weight,
Nr BITS=number of bits inside the cone,
N BITS=axial force given by the bits weight,
N TOTAL=the total axial force (bits+con),
Area cone=area of the cone section,
Area total=area of the cone section plus the bits section;
σ=N/A (axial stress in the bits); and
stress/fyc shows percent capacity of the bits used when the tower structure is lifted (for example 0.425 means 42.5% is used)

TABLE 3

| | | | N cone | Nr. | | N total | Area cone | Area total | N/A | |
|---|---|---|---|---|---|---|---|---|---|---|
| Level | D[mm] | V [m³] | [kN] | BITS | N BITS [kN] | [kN] | [m²] | [m²] | [Mpa] | stress/fy |
| 20 | 105000 | 3259402 | 148628748 | 1 | 458421200 | 607049948 | 407.425297 | 1256.637061 | 483.075 | 0.40256 |
| 19 | 135000 | 16336282 | 744934450 | 5 | 2292106000 | 3.037E+09 | 2042.03522 | 6283.185307 | 483.36 | 0.4028 |
| 18 | 165000 | 20106193 | 916842400 | 5 | 2292106000 | 3.209E+09 | 2513.27412 | 6283.185307 | 510.72 | 0.4256 |
| 17 | 195000 | 23876104 | 1.089E+09 | 5 | 2292106000 | 3.381E+09 | 2984.51302 | 6283.185307 | 538.08 | 0.4484 |
| 16 | 225000 | 27646015 | 1.261E+09 | 5 | 2292106000 | 3.553E+09 | 3455.75192 | 6283.185307 | 565.44 | 0.4712 |
| 15 | 255000 | 31415927 | 1.433E+09 | 9 | 4125790800 | 5.558E+09 | 3926.99082 | 11309.73355 | 491.46667 | 0.40956 |
| 14 | 285000 | 35185838 | 1.604E+09 | 9 | 4125790800 | 5.73E+09 | 4398.22972 | 11309.73355 | 506.66667 | 0.42222 |
| 13 | 315000 | 38955749 | 1.776E+09 | 9 | 4125790800 | 5.902E+09 | 4869.46861 | 11309.73355 | 521.86667 | 0.43489 |
| 12 | 345000 | 42725660 | 1.948E+09 | 13 | 5959475600 | 7.908E+09 | 5340.70751 | 16336.2818 | 484.06154 | 0.40338 |
| 11 | 375000 | 46495571 | 2.12E+09 | 13 | 5959475600 | 8.08E+09 | 5811.94641 | 16336.2818 | 494.58462 | 0.41215 |
| 10 | 405000 | 50265482 | 2.292E+09 | 13 | 5959475600 | 8.252E+09 | 6283.18531 | 16336.2818 | 505.10769 | 0.42092 |
| 9 | 435000 | 54035394 | 2.464E+09 | 17 | 7793160400 | 1.026E+10 | 6754.42421 | 21362.83004 | 480.14118 | 0.40012 |
| 8 | 465000 | 57805305 | 2.636E+09 | 17 | 7793160400 | 1.043E+10 | 7225.6631 | 21362.83004 | 488.18824 | 0.40682 |
| 7 | 495000 | 61575216 | 2.808E+09 | 17 | 7793160400 | 1.06E+10 | 7696.902 | 21362.83004 | 496.23529 | 0.41353 |
| 6 | 525000 | 65345127 | 2.98E+09 | 21 | 9626845200 | 1.261E+10 | 8168.1409 | 26389.37829 | 477.71429 | 0.3981 |
| 5 | 555000 | 69115038 | 3.152E+09 | 21 | 9626845200 | 1.278E+10 | 8639.3798 | 26389.37829 | 484.22857 | 0.40352 |
| 4 | 585000 | 72884950 | 3.324E+09 | 21 | 9626845200 | 1.295E+10 | 9110.6187 | 26389.37829 | 490.74286 | 0.40895 |
| 3 | 615000 | 76654861 | 3.495E+09 | 25 | 11460530000 | 1.496E+10 | 9581.85759 | 31415.92654 | 476.064 | 0.39672 |
| 2 | 645000 | 80424772 | 3.667E+09 | 25 | 11460530000 | 1.513E+10 | 10053.0965 | 31415.92654 | 481.536 | 0.40128 |
| 1 | 675000 | 84194683 | 3.839E+09 | 25 | 11460530000 | 1.53E+10 | 10524.3354 | 31415.92654 | 487.008 | 0.40584 |

Design checking of the cones:

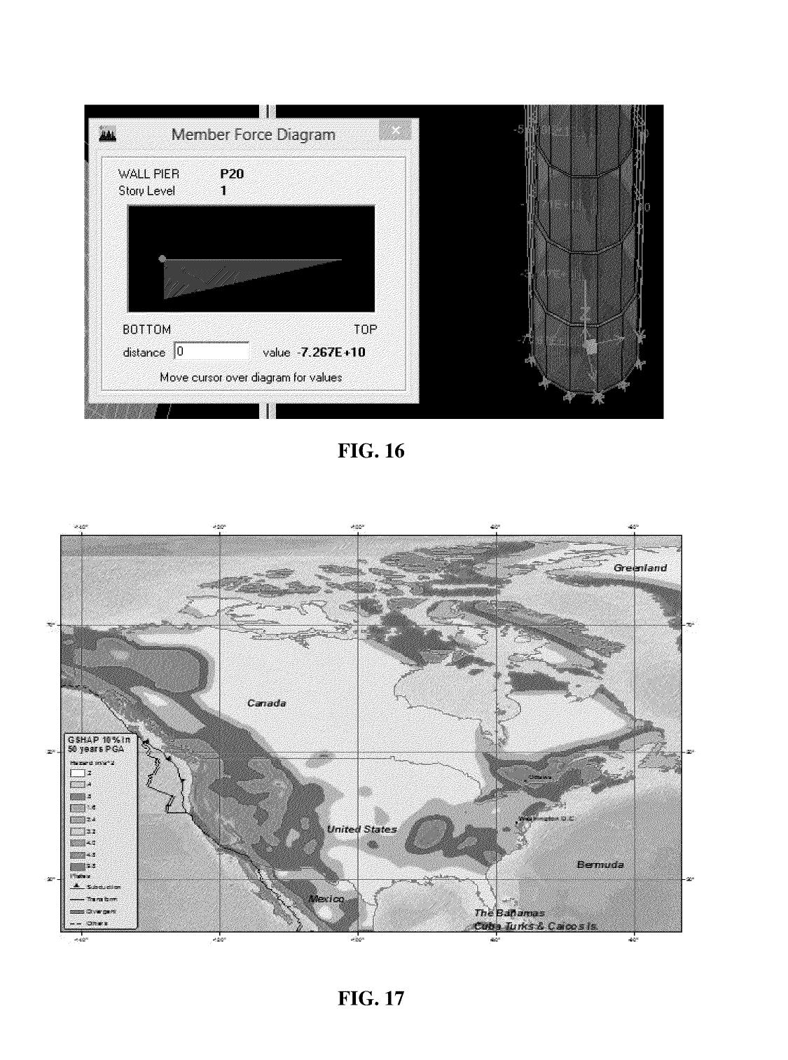

A. Bottom cone design check:
i) Axial force from self-weight at the bottom of the tower, estimated from the ETAB modelling software as shown in FIG. 16.
Axial force in the bottom cone, Nbase=7.26E+10 kN or 7.26E+13 N
ii) Cone dimensions:
   Outer diameter D=6800 m
   Wall thickness t=10 m
   Thus, Area A=106735.6104 m2 or 1.06736E+11 mm2
iii) Stress check: Stress a=680.19 MPa
iv) Material Properties: Titanium Ti-10V-2Fe-3Al
   Compressive Yield Strength fyc=1200 Mpa
   Ultimate bearing strength fuc=1700 Mpa

Here, the condition for the checking cone dimensions is that calculated stress should be less than strength of the cone material.

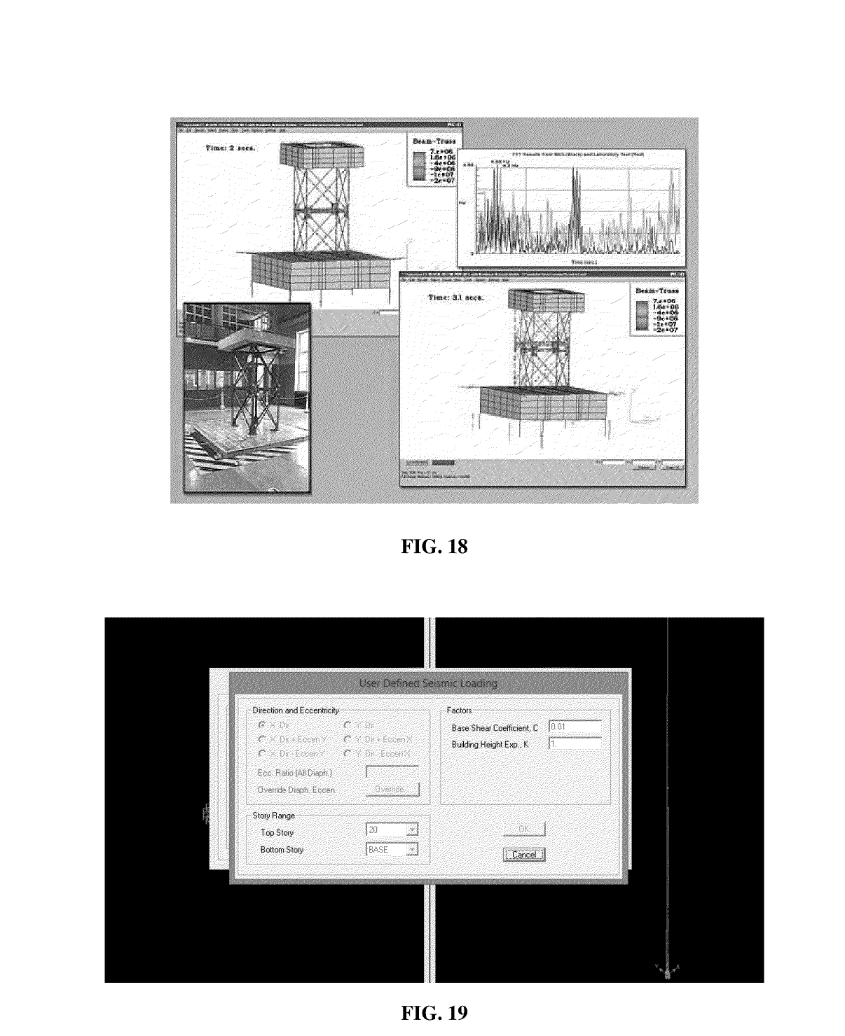

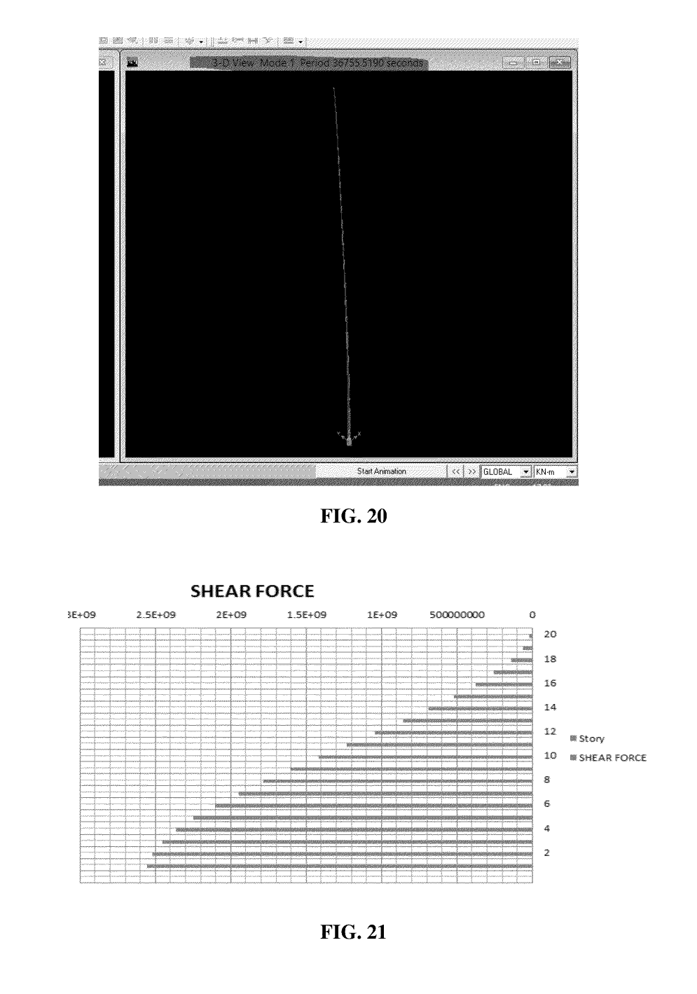

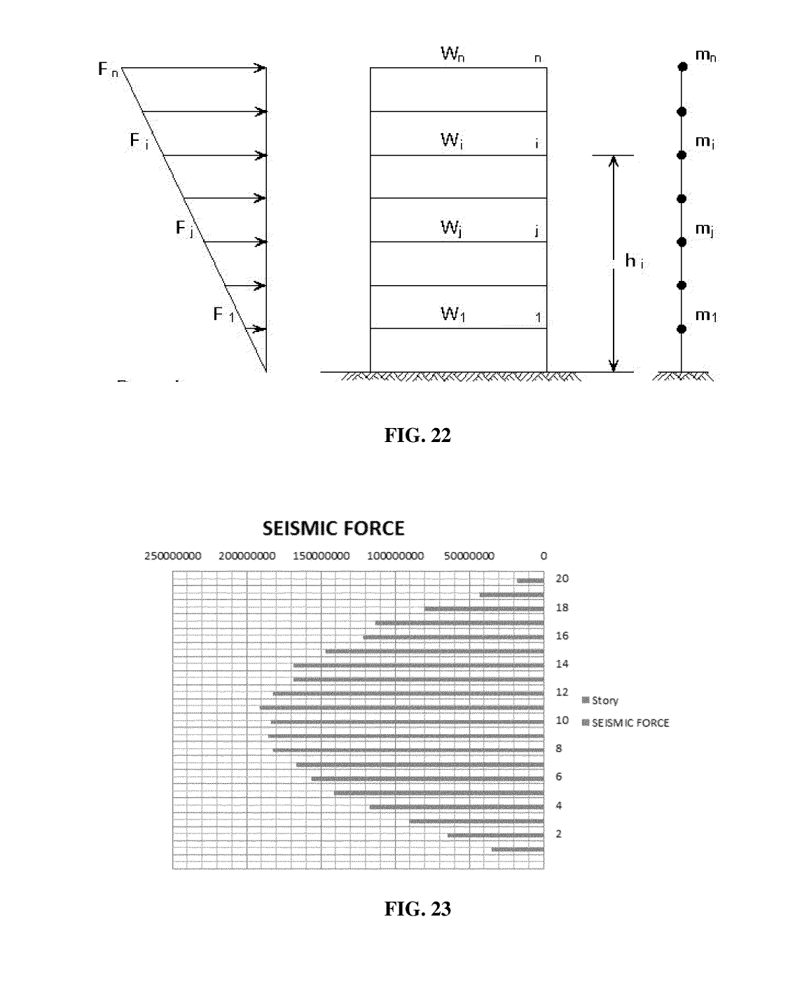

Simulating a small earthquake:
FIG. 17 shows a seismic hazard map of Canada. When such a tower is designed for real construction, an advanced analysis should be done such as machete on scale (like wind in turbine analysis), model that will be subjected to dynamic earthquake tests, as illustrated in
FIG. 18. The intent for the small structural analysis is to simulate a small earthquake (because, in Canada the tower can be built in 0 seismic region, but just in case the seismic hazard changes or a new fault plane form in that zone) and to see how the structure manifest.
FIG. 19 illustrates modeling of earthquake force on the X direction using Etabs software. From the figure, the coefficient of 0.01 mean that the seismic force will be only 1% of the structural mass, a coefficient that is very small compared with a medium earthquake in active seismic zone. For example, in zone near a fault, medium seismic activity means an acceleration of the ground of 0.2 . . . 0.35 g and for usual buildings that give an seismic coefficient of 0.1-0.2 (compared to 0.01)→10 . . . 20% of the mass.

NATURAL PERIOD:

Another very important characteristic of earthquake waves is their period or frequency, that is, whether the waves are quick and abrupt (or) slow and rolling. This phenomenon is particularly important for determining the building seismic forces. All objects have a natural or fundamental period; this is the rate at which they will move back and forth if they are given a horizontal push. In fact, without pulling and pushing it back and forth, it is not possible to make an object vibrate at anything other than its natural period.

For example, when a child in a swing is started with a push, to be effective this shove must be as close as possible to the natural period of the swing. If correctly gauged, a very small push will set the swing going nicely. Similarly, when earthquake motion starts a building vibrating, it will tend to sway back and forth at its natural period.

Period is the time in seconds (or fractions of a second) that is needed to complete one cycle of a seismic wave. Frequency is the inverse of this, i.e. the number of cycles that will occur in a second, and is measured in “Hertz”. One Hertz is one cycle per second.

| | | | |
|---|---|---|---|
| Story | Load | SHEAR | SEISMIC |

When using the basic formula for the usual buildings, the natural period will be around:

T=0.1*H^{3/4}

H=160*1000=160000 m
[symbol] T=800 s

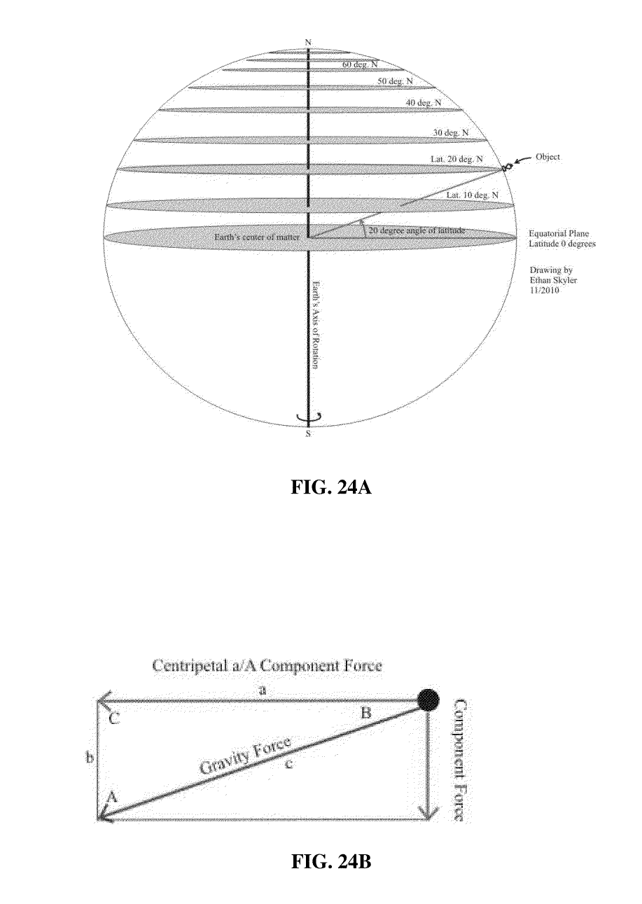

The above value is what we expect from the finite element program if the formula was true for special building like this. From the ETABS Building model the natural period is shown in FIG. 20. The value of 36755 s, is about 50 folds bigger than what was expected with the formula presented in the seismic building design. The following Table. 4 shows seismic lateral forces for 1-20 storeys or levels.

TABLE 4

| | | FORCE N | FORCE N |
|---|---|---|---|
| 20 | EARTHQUAKE COMBO | 17954249.89 | 17954949.9 |
| 19 | EARTHQUAKE COMBO | 60950641.7 | 179547600 |
| 18 | EARTHQUAKE COMBO | 141171227.7 | 145556577 |
| 17 | EARTHQUAKE COMBO | 254280141.1 | 113108913 |
| 16 | EARTHQUAKE COMBO | 375872165 | 121592024 |
| 15 | EARTHQUAKE COMBO | 522918417 | 147046252 |
| 14 | EARTHQUAKE COMBO | 691059068 | 168140651 |
| 13 | EARTHQUAKE COMBO | 859619149 | 168560081 |
| 12 | EARTHQUAKE COMBO | 1041777065 | 182157916 |
| 11 | EARTHQUAKE COMBO | 1233143584 | 191366519 |
| 10 | EARTHQUAKE COMBO | 1416774920 | 183631336 |
| 9 | EARTHQUAKE COMBO | 1602057454 | 185282534 |
| 8 | EARTHQUAKE COMBO | 1784570587 | 182513133 |
| 7 | EARTHQUAKE COMBO | 1951103614 | 166533027 |
| 6 | EARTHQUAKE COMBO | 2107249811 | 156146197 |
| 5 | EARTHQUAKE COMBO | 2248558096 | 141308285 |
| 4 | EARTHQUAKE COMBO | 2365550363 | 116992267 |
| 3 | EARTHQUAKE COMBO | 2456263879 | 90713516 |
| 2 | EARTHQUAKE COMBO | 2521234358 | 64970479 |
| 1 | EARTHQUAKE COMBO | 2555970364 | 34736006 |

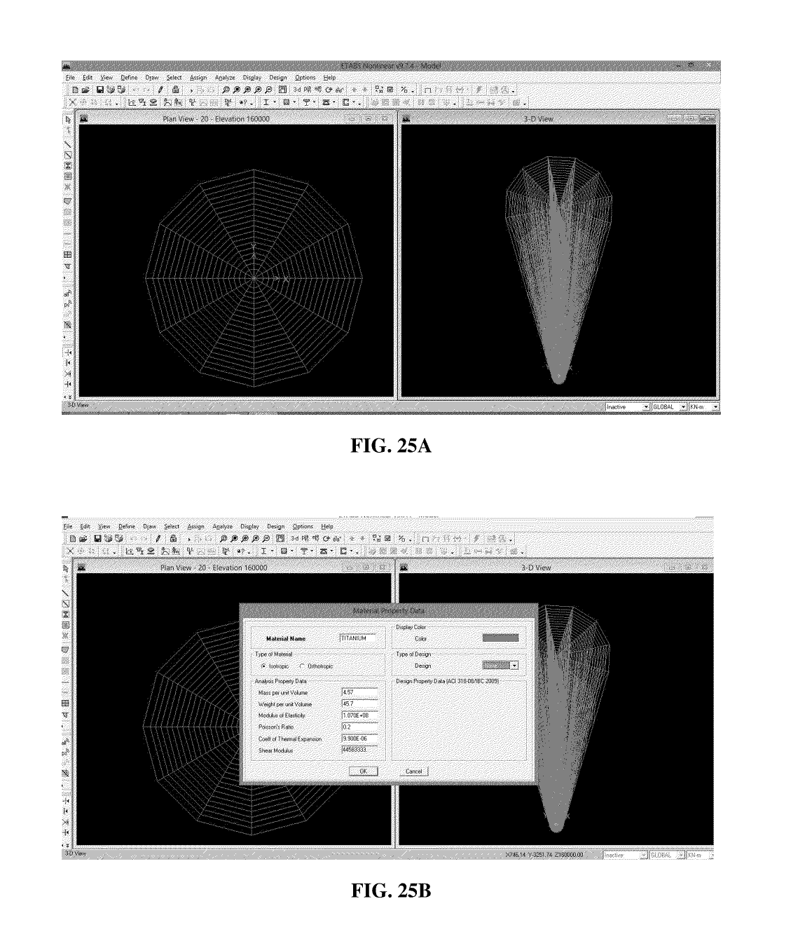

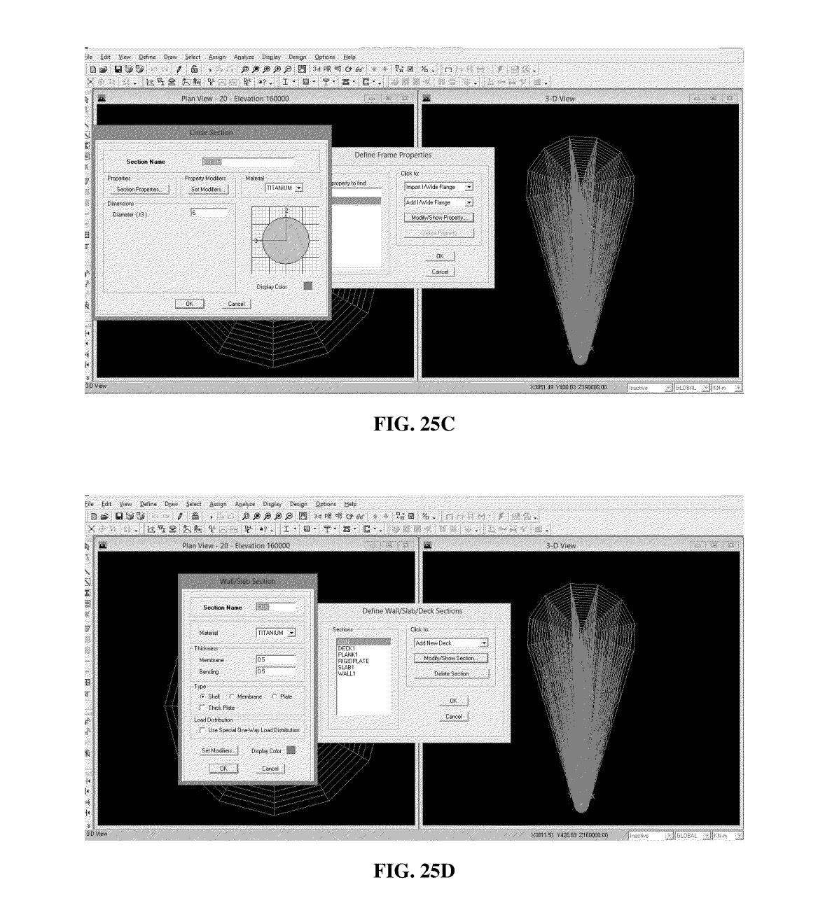

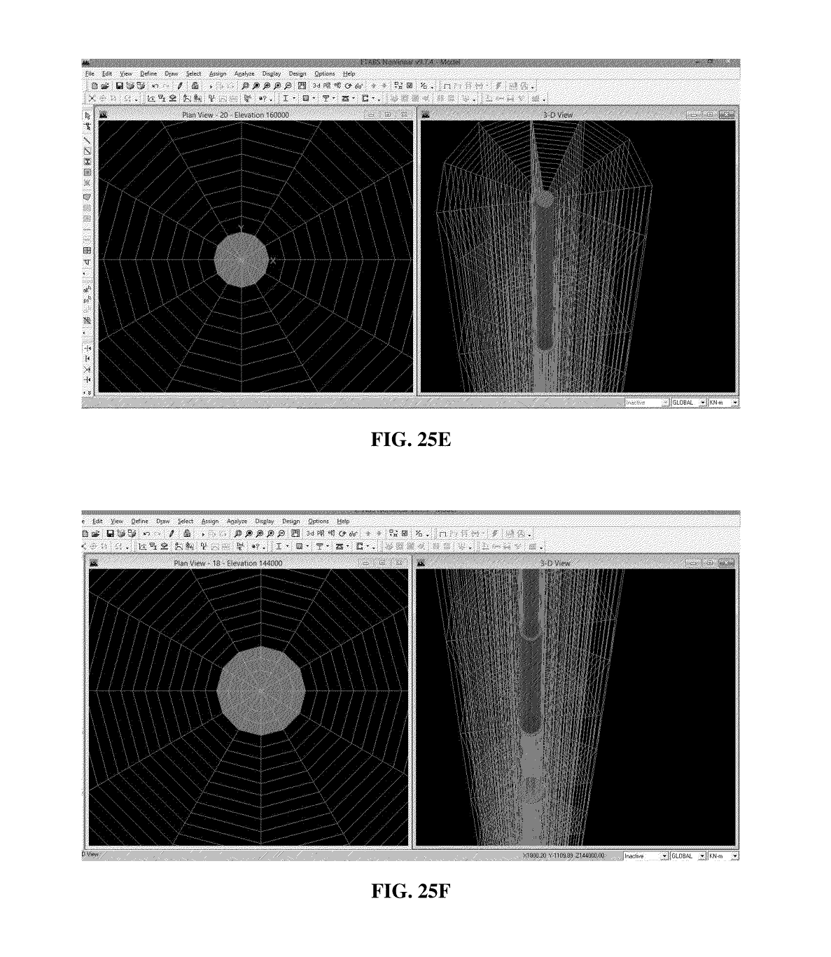

FIG. 21 illustrates a graph showing change in shear forces with number of storeys 1-20. FIG. 22 illustrates distribution of seismic lateral forces. FIG. 23 shows non-cumulative distribution of seismic forces.

$$V = β ( T ) {\sum }_{j = 1}^{n} {W}_{j}$$

Horizontal static force acting on mass

$${m}_{i} = \frac{{W}_{i}}{g} \text{:} {F}_{i} = V \times \frac{{W}_{j} {h}_{j}}{{\sum }_{j = 1}^{n} {W}_{j} {h}_{j}^{k}}$$

where
Hᵢ=height of mass mᵢ from the base of the structure
Wⱼ=weight of mass mⱼ at levelⱼ
hⱼ=height of mass mⱼ from the base
K=numerical coefficient depending on the fundamental period of the structure, e.g. for T<0,5 seconds K=1 (triangular distribution of Fᵢ)

### Base Shear:

Seismic forces in the structure and stresses:

The following Table. 5 shows in the first column, the Moment M in every story given by the effect of overturning produced by seismic lateral forces. The second and third columns shows the section properties—moment of inertia I and the D/2—that are involved in determining the stress in the section.

The formula from which the normal stress SIGMA deduced is:

$$σ = \frac{M}{I} * z$$

With the value of sigma, we have to compare to the material design limit (fy for yield of fu—for rupture) and from the table. 5, it is clear that the structure will not hold (fy=1200 MPa). At a normal project bigger sections can be made as an iterative process, by choosing larger and larger dimension until this checks in (or change the material but clear this is not the case). The problem is that, lack any tools to verify these numbers, hence it's only an approximate view. But with this approximate values, it can be see that the earthquake will be a big problem so, for installing such as structure in a seismic zone, additional support cables or stay cables can be used to help the structure to resist the lateral forces.

TABLE 5

| M3 | | | Sigma |
|---|---|---|---|
| [kN] | I | z | MPa |
| 4.63E+09 | 5.48273E+17 | 52500 | 442.96 |
| 1.86E+11 | 4.32018E+18 | 67500 | 2910.82 |
| 3.29E+11 | 8.05033E+18 | 82500 | 3368.53 |
| 7.84E+11 | 1.34769E+19 | 97500 | 5672.63 |
| 1.51E+12 | 2.09181E+19 | 112500 | 8142.47 |
| 1.87E+12 | 3.06919E+19 | 127500 | 7755.88 |
| 3.04E+12 | 4.31164E+19 | 142500 | 10057.14 |
| 2.76E+12 | 5.85097E+19 | 157500 | 7432.23 |
| 4.11E+12 | 7.71899E+19 | 172500 | 9178.11 |
| 9.66E+12 | 9.94751E+19 | 187500 | 18208.08 |
| 7.97E+12 | 1.25683E+20 | 202500 | 12847.65 |
| 1.26E+13 | 1.56133E+20 | 217500 | 17524.51 |
| 1.04E+13 | 1.91141E+20 | 232500 | 12650.32 |
| 1.36E+13 | 2.31027E+20 | 247500 | 14516.14 |
| 1.41E+13 | 2.76109E+20 | 262500 | 13424.06 |
| 1.72E+13 | 3.26704E+20 | 277500 | 14618.07 |
| 2.11E+13 | 3.8313E+20 | 292500 | 16108.76 |
| 2.60E+13 | 4.45706E+20 | 307500 | 17937.83 |
| 2.94E+13 | 5.1475E+20 | 322500 | 18388.30 |
| 3.44E+13 | 5.9058E+20 | 337500 | 19641.51 |

The Earth centripetal force:

Rotational velocity ω due to the Earth's rotation :

$$ω = \frac{angular distance}{time} = \frac{360 °}{24 hr} = 15 \frac{\text{?}}{hr} = 15 \frac{\text{?}}{hr} \frac{1 hr}{3600 s} = 4.2 \times {10}^{- 3} \frac{\text{?}}{\text{?}} = 0.0042 \frac{\text{?}}{\text{?}}$$

$$\text{?} \text{indicates text missing or illegible when filed}$$

Earth radius—the surface of the Earth :

$$\begin{matrix}v = r ω = ( 6.37 \times {10}^{6} m ) ( 7.3 \times {10}^{- 3} \frac{\text{?}}{\text{?}} ) = 465 \frac{\text{?}}{\text{?}} = > \\ = 465 [ m \text{/} s ]\end{matrix}$$

$$\text{?} \text{indicates text missing or illegible when filed}$$

The linear velocity for the surface of the Earth.

On the top of the tower we will have the radius of R′=R+160*1000, as 160 km height

R′=6530000 [m]

The linear velocity on the 160 km height will be :

v′=477 [m/s]

Centripetal force Fc: In the case of an object that is swinging around on the end of a rope in a horizontal plane, the centripetal force on the object is supplied by the tension of the rope. The rope example is an example involving a ‘pull’ force. The centripetal force can also be supplied as a ‘push’.

$$F = ma \text{?} = \frac{{mv}^{2}}{r}$$

$$\text{?} \text{indicates text missing or illegible when filed}$$

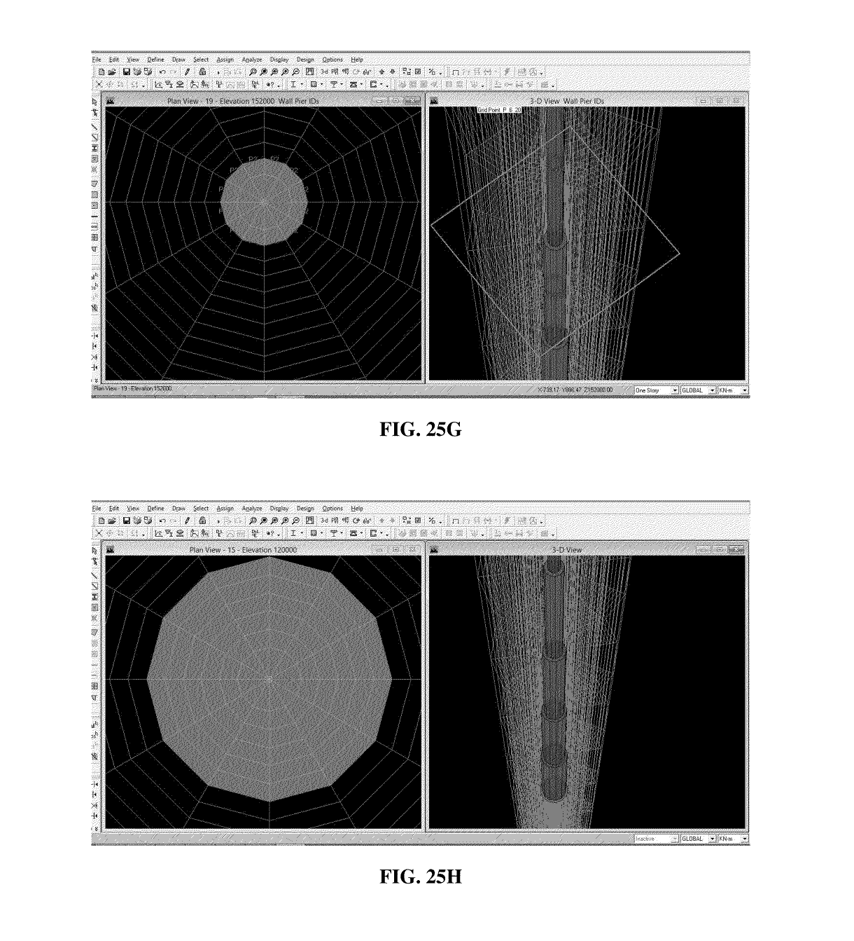

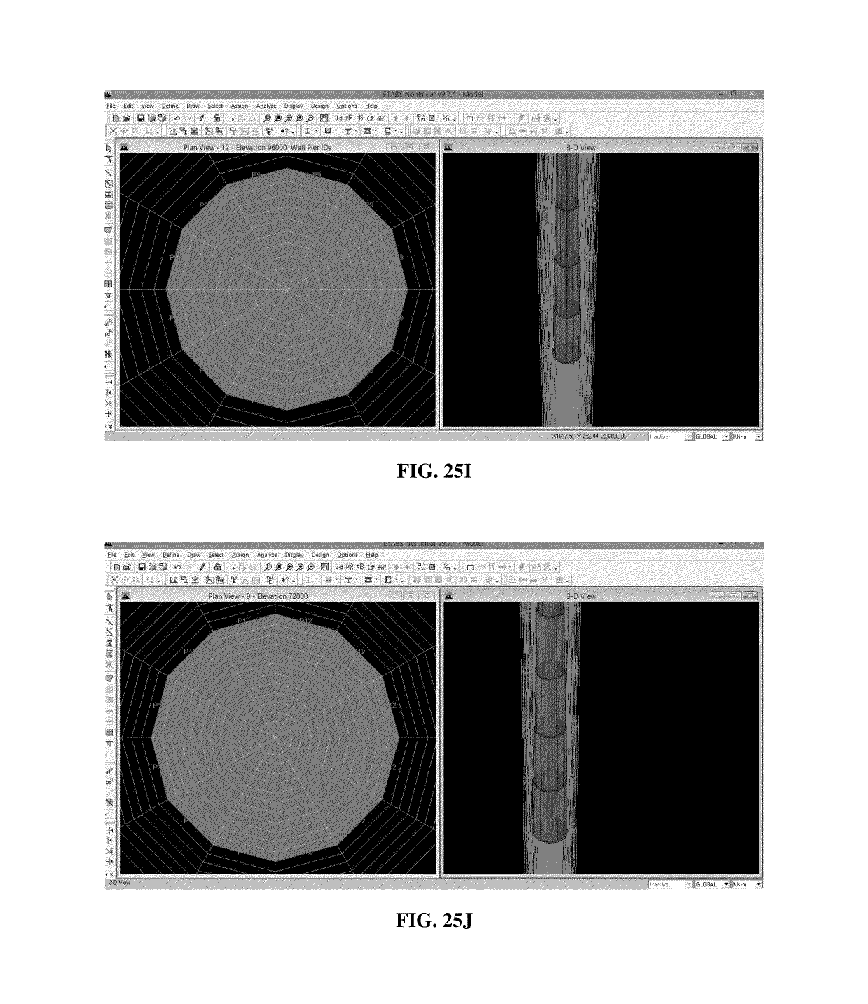

The distribution of centrip shown in the following Table. 6. The tower can be built around the Canadian zone the angle of latitude will be around 50 degree. FIG. 24A shows the latitude angle of rotation of object from earth's center of matter and FIG. 24B shows a graph of gravity force in relation to centripetal force and component force.

TABLE 6

| Story | Height [m] | Mass [kg] | R [m] | v [m/s] | Fc [kN] |
|---|---|---|---|---|---|
| 20 | 160000 | 65745031.7 | 7E+06 | 476.69 | 2287.82 |
| 19 | 152000 | 165793859 | 7E+06 | 476.106 | 5762.29 |
| 18 | 144000 | 326487261 | 7E+06 | 475.522 | 11333.4 |
| 17 | 136000 | 487427443 | 7E+06 | 474.938 | 16899.3 |
| 16 | 128000 | 556729102 | 6E+06 | 474.354 | 19278.3 |
| 15 | 120000 | 718162844 | 6E+06 | 473.77 | 24837.8 |
| 14 | 112000 | 879843366 | 6E+06 | 473.186 | 30392.1 |
| 13 | 104000 | 949885366 | 6E+06 | 472.602 | 32771 |
| 12 | 96000 | 1112059448 | 6E+06 | 472.018 | 38318.6 |
| 11 | 88000 | 1274480310 | 6E+06 | 471.434 | 43860.8 |
| 10 | 80000 | 1345262649 | 6E+06 | 470.85 | 46239.4 |
| 9 | 72000 | 1508177071 | 6E+06 | 470.266 | 51774.8 |
| 8 | 64000 | 1671338273 | 6E+06 | 469.682 | 57304.8 |
| 7 | 56000 | 1742860953 | 6E+06 | 469.098 | 59682.8 |
| 6 | 48000 | 1906515715 | 6E+06 | 468.514 | 65205.7 |
| 5 | 40000 | 2070417257 | 6E+06 | 467.93 | 70723.2 |
| 4 | 32000 | 2142680276 | 6E+06 | 467.346 | 73100.2 |
| 3 | 24000 | 2215190076 | 6E+06 | 466.762 | 75479.6 |
| 2 | 16000 | 2379831958 | 6E+06 | 466.178 | 80988 |
| 1 | 8000 | 2544720620 | 6E+06 | 465.594 | 86490.9 |

The horizontal component that give the overturning moment is given in Table. 7

TABLE 7

| Angle | Fcentr [kN] | Fhoriz [kN] |
|---|---|---|
| 50 | 2287.8199 | 1922.5 |
| | 5762.2879 | 4842.3 |
| | 11333.387 | 9523.9 |
| | 16899.34 | 14201.1 |
| | 19278.327 | 16200.3 |
| | 24837.813 | 20872.1 |
| | 30392.058 | 25539.5 |
| | 32770.994 | 27538.7 |
| | 38318.582 | 32200.5 |
| | 43860.835 | 36857.8 |
| | 46239.435 | 38856.7 |
| | 51774.841 | 43508.3 |
| | 57304.818 | 48155.3 |
| | 59682.799 | 50153.6 |
| | 65205.739 | 54794.7 |
| | 70723.155 | 59431.2 |
| | 73100.233 | 61428.8 |
| | 75479.558 | 63428.2 |
| | 80988.047 | 68057.2 |
| | 86490.886 | 72681.4 |

The following Table. 8 shows comparison between the seismic lateral forces and centripetal forces. The forces from earthquake are about 10,000× times bigger than the forces from moving the Earth. At this values of lateral forces and compared with the stresses analysis, it can be seen clear that the structure has no problem taking this extra overturning moment.

TABLE 8

| | Fcentr | Fseism |
|---|---|---|
| Story | [kN] | [kN] |
| 20 | 1922.5 | 17954249.9 |
| 19 | 4842.3 | 60950641.7 |
| 18 | 9523.9 | 141171228 |
| 17 | 14201.1 | 254280141 |
| 16 | 16200.3 | 375872165 |
| 15 | 20872.1 | 522918417 |
| 14 | 25539.5 | 691059068 |
| 13 | 27538.7 | 859619149 |
| 12 | 32200.5 | 1041777065 |
| 11 | 36857.8 | 1233143584 |
| 10 | 38856.7 | 1416774920 |
| 9 | 43508.3 | 1602057454 |
| 8 | 48155.3 | 1784570587 |
| 7 | 50153.6 | 1951103614 |
| 6 | 54794.7 | 2107249811 |
| 5 | 59431.2 | 2248558096 |
| 4 | 61428.8 | 2365550363 |
| 3 | 63428.2 | 2456263879 |
| 2 | 68057.2 | 2521234358 |
| 1 | 72681.4 | 2555970364 |

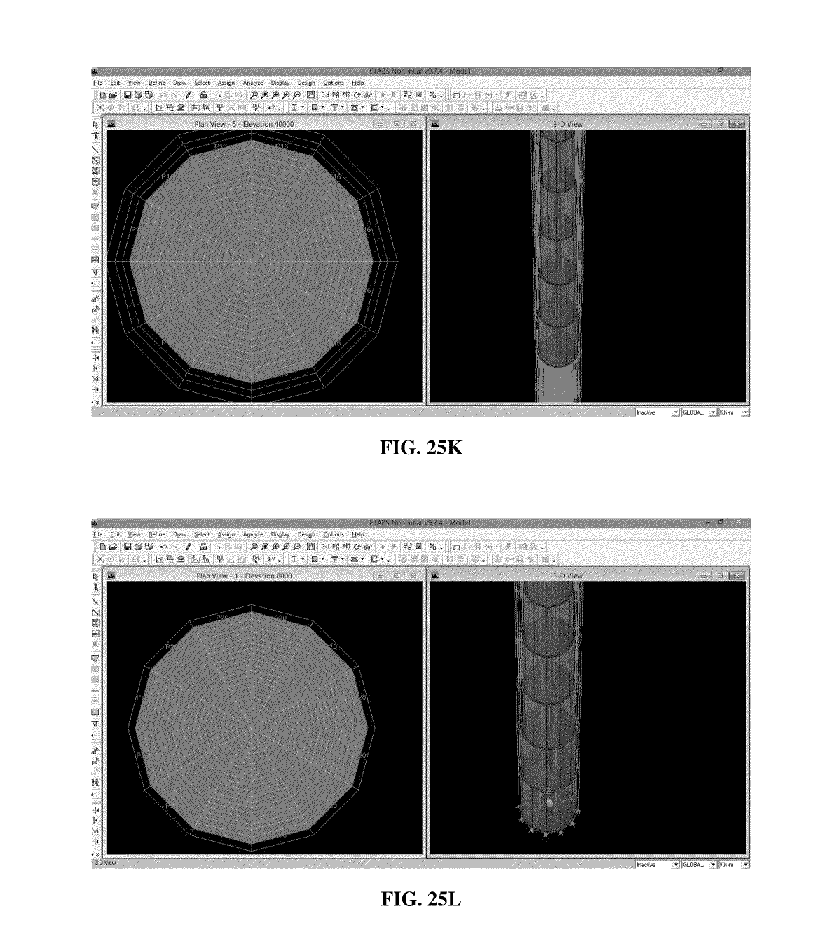

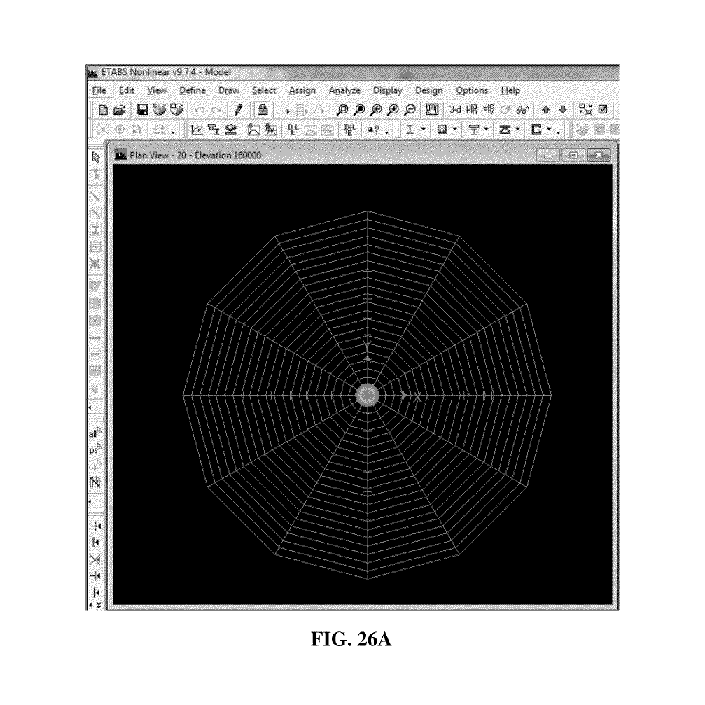

FIG. 25A-25L shows images of finite element method modelling of the tower structure using ETABS software. Similarly, FIG. 26A-26E shows a second model of the tower structure at different elevations such as levels or storeys 20, 17, 10, 5 and 1.

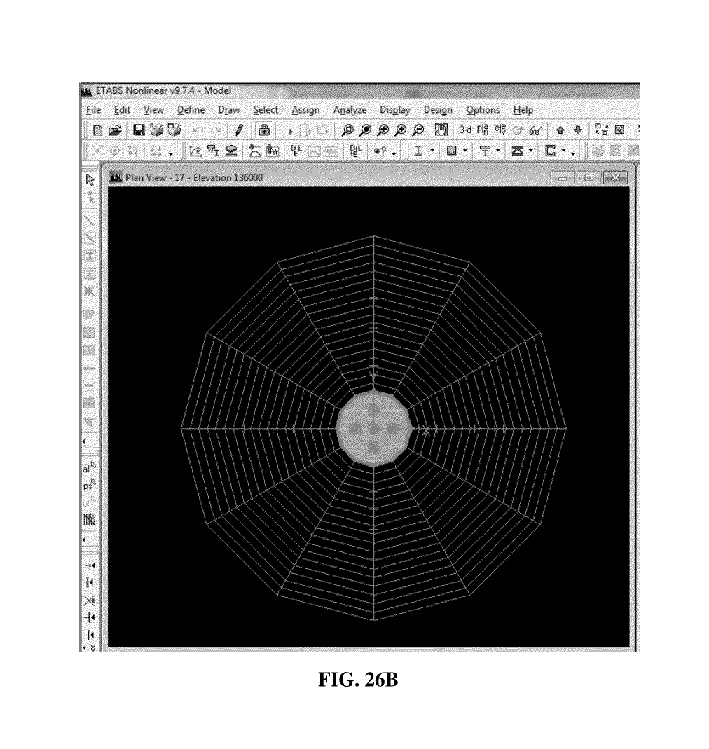

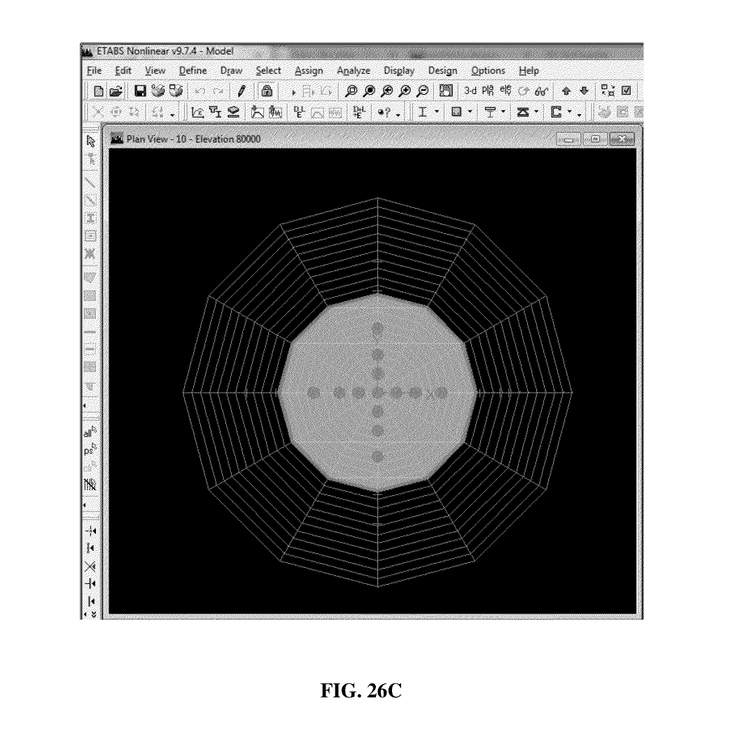

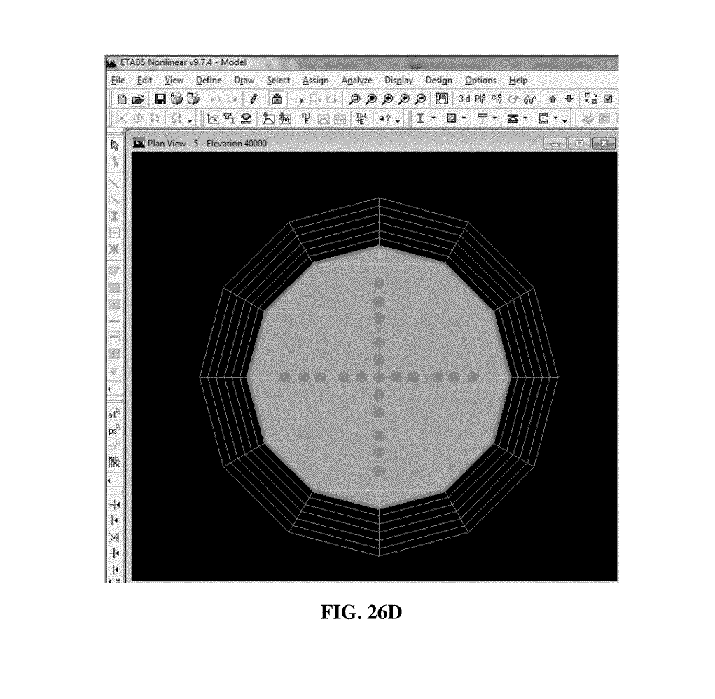

Axial forces in the lowest cone, for example axial forces at pier 20 is shown in FIG. 27A. Bending moment in the lowest cone during simulation of a minor earthquake is shown in FIG. 27B. Axial force in one of the bits at the bottom of the tower structure is shown in FIG. 27C. From the model figures, it can be seen that the axial load is smaller in the bits as cones take almost all of the axial weight.

Lateral forces from small seismic force:
1. Moment from lateral force: The seismic force will produce a moment that has maximum value at the base of the tower.
M=8.04E+10 kNm, from small earthquake (seismic coefficient of 0.01) 1% of its weight.
2. Moment of inertia:
I=6.16E+11 [m̂4]
3. Stress check (seism only):
Stress σ=887.05MPA
4. Stress check (seism+self-weight):
Seism+self-weight=σ t=1567.24 MPA

Design of Cables:

Cables will be added to add extra lateral stability for the tower. The cables are designed to carry their own weight at about 40% of capacity so the rest of 60% is purposed to be used in case of emergency situations, such as, an earthquake, or the like. The axial force in the outside cable is 2.72*10̂11 units [kN] for only a 1 m thick cable, so the use of the cable that goes from the ground to the top of the tower at 160 km it's not possible. Because the stress will be bigger greater than design value, it might not hold.

Choosing the distance between the tower and cable support on the ground:

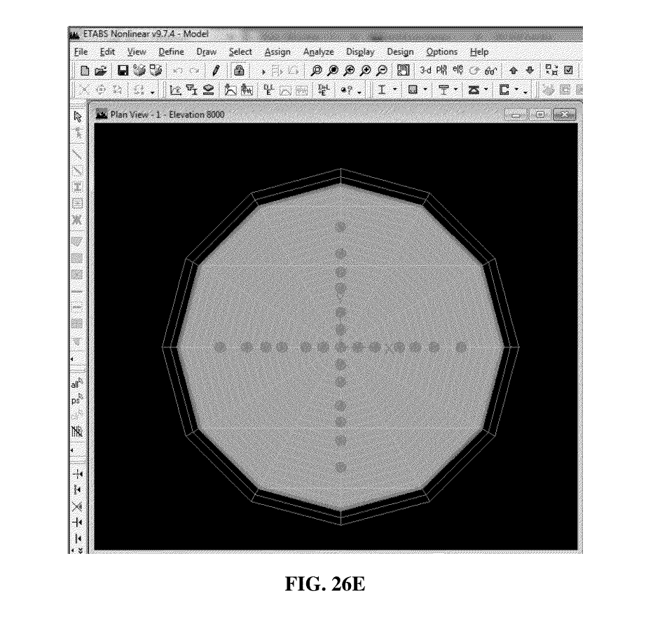

The distance between the tower axis and the point of cables ground support will be 2× the height of one story (8 km×2=16 km). As shown in FIG. 28, distance calculation for tower axis and point of cable ground support.

From the figure, on decomposing the forces by the angle alpha, angle that depends on the X (the distance) and the height (H—the height is where the cables are fixed on the tower). The force in the cable “F_{CABLE}” is the lateral force (the seismic force) divided by the sin of alpha:

$$Fcable = \frac{Fseism}{sin α}$$

The force in the tower (and by force I mean the extra axial force given by equilibrium):

Ftower=Fc*cos α

Three different heights (8000, 16000 and 24000) are tested with three types of distance between tower and cable support (8000, 16000 and 24000) and the results are given in Table. 9.

TABLE 9

| | | α | | | | |
|---|---|---|---|---|---|---|
| X | Height | [degree] | SEISM | F_{CABLE} | F_{TOWER} | Fc − Ft |
| 8000 | 8000 | 45 | 1 | 1.4 | 1 | 0.4 |
| | 16000 | 27 | 1 | 2.2 | 2 | 0.2 |
| | 24000 | 18 | 1 | 3.2 | 3 | 0.2 |
| 16000 | 8000 | 63 | 1 | 1.1 | 0.5 | 0.6 |
| | 16000 | 45 | 1 | 1.4 | 1 | 0.4 |
| | 24000 | 34 | 1 | 1.8 | 1.5 | 0.3 |
| 24000 | 8000 | 72 | 1 | 1.1 | 0.3 | 0.7 |
| | 16000 | 56 | 1 | 1.2 | 0.7 | 0.5 |
| | 24000 | 45 | 1 | 1.4 | 1 | 0.4 |

From the table. 9, if X (the distance between the tower and the support for the cables) is equal to 8000 m, then the cables will take 40% more than the tower, if X is chosen at 16000 m, the cables will take 60% and for 24000 m 70% . The more the distance between the tower and the cable support, the more force will be absorbed in the cable and thus the more use for them. However because of the extra cost for this, 16 km distance for X is preferred.

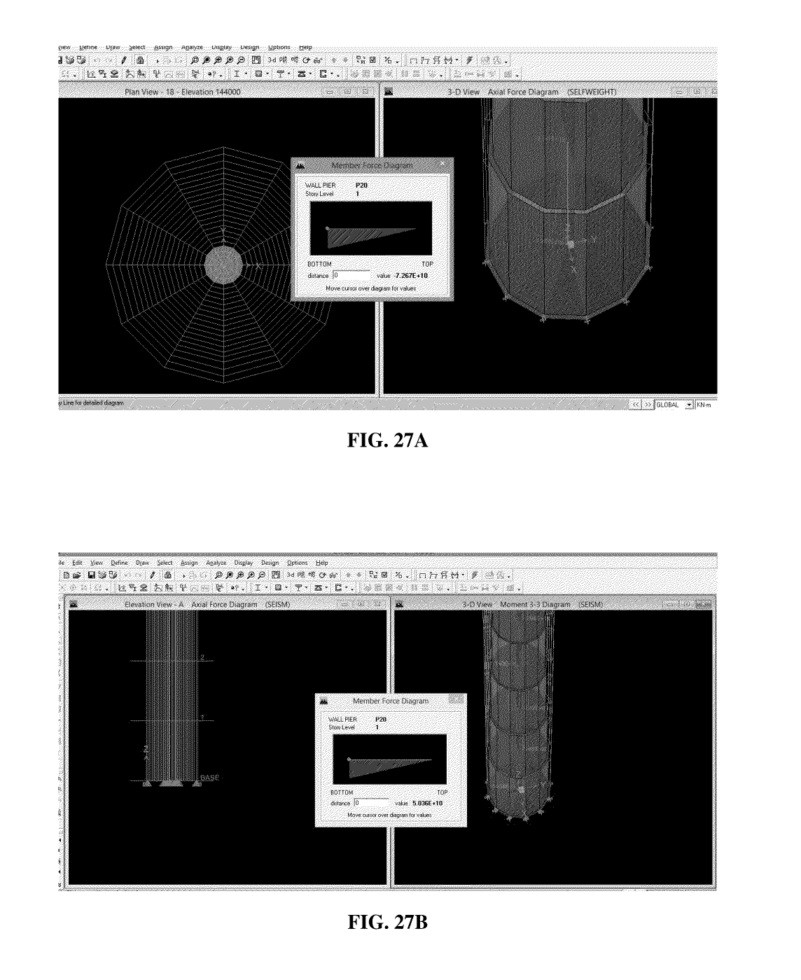

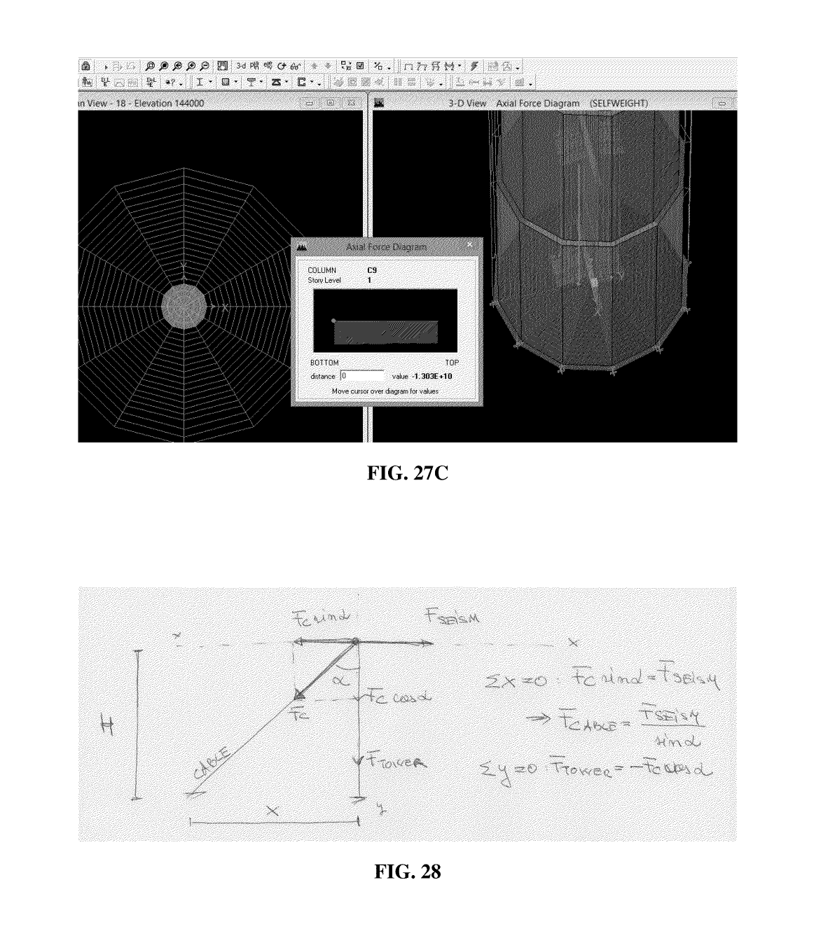

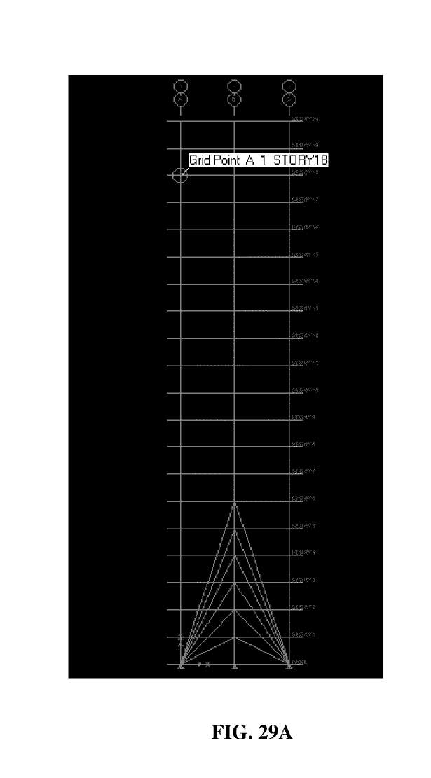

FIG. 29A shows cable supporting the tower structure up until the 6^{th} storey or level. FIG. 29B shows seismic deformation of the tower structure. FIG. 29C shows moment diagram in the tower structure showing the decreasing slope and cables help with the overturning moment. From the pictures, it can be seen that the biggest axial force is in the topmost cable at it has the value of 9.8*10̂8 kN.

Cable cross section:

The biggest axial force in the top most cable has the value of 9.8*10̂8 kN. Aramid fibers which have high strength to weight ratio equal to force per unit area at failure/density can be used for stay cables.

Stress=force/area (1m diameter)

$$σ = \frac{N}{A}$$

$$A = PI * \frac{{D}^{2}}{4} = 0.78 {m}^{2} = 7.8 * {10}^{5} {mm}^{2}$$

$$σ = \frac{N}{A} = \frac{9.8 * {10}^{11}}{7.8 * {10}^{5}} = 1256410 MPa > 2800 MPa$$

For determining necessary diameter,

$$D = \sqrt{\frac{4 * N}{PI * fy}} = \sqrt{\frac{4 * 9.8 * {10}^{11}}{PI * 2800}} = 21.1 m$$

So, for the cables to help and take the load from the earthquake, the cable diameter should be greater than 25 m. In the event of a small 0.01 earthquake, an accidental earthquake in the zone were hazard maps indicates 0 seismic. It's clear that this tower cannot withstand a large seismic event and for that reason there are tall buildings in Dubai, New York and not in California or Chile or Japan for that matter. It's clear that the seismic zone determine the height of the buildings so this type of construction can be only made where seismic hazard is considered 0 and the structure can have extra cables that ensure stability to an hypothetical small earthquake C=0.01, Earthquake that is not on the hazard maps.

Buckling:

Buckling is caused by a bifurcation in the solution to the equations of static equilibrium. At a certain stage under an increasing load, further load can be sustained in one of two states of equilibrium: an un-deformed state or a laterally-deformed state. There is a need to prevent buckling in the tower bits (columns) when the structure is lifting (in this stage because it is here that the maximum axial force is applied to the columns).

Buckling is caused be geometrical imperfections of the column vertical ax, imperfections that when the axial force is applied will cause a bending moment and this bending moment will cause the deformation of the ax, more deformation will result in increasing the bending moment and so the column will lose stability and fail before the axial capability is reached. Buckling in the main reason for structural columns failure so this matter is very important in the rising stage of the structure. In the usual structure's buckling is prevented by decrease the height or adding extra support that prevent the buckling deformed shape to appear.

In present case bits (columns) are not made from a single material, is made from a lot of parts that adds up, bits.

### Solution 1

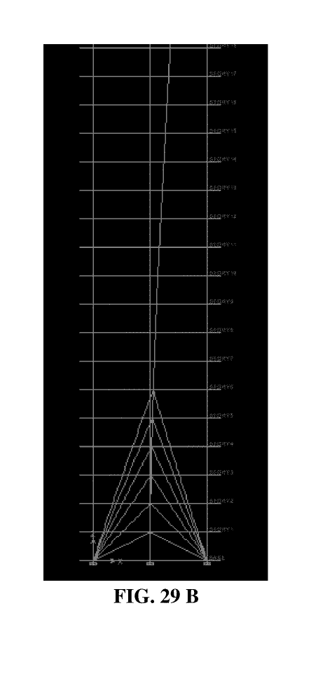

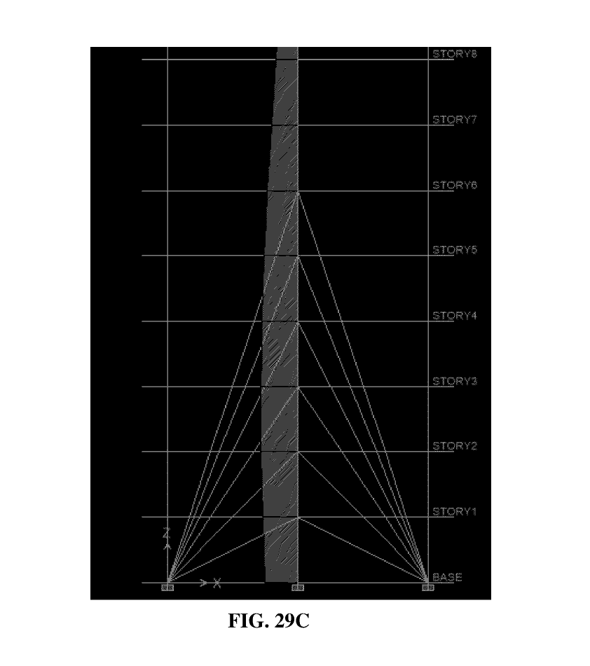

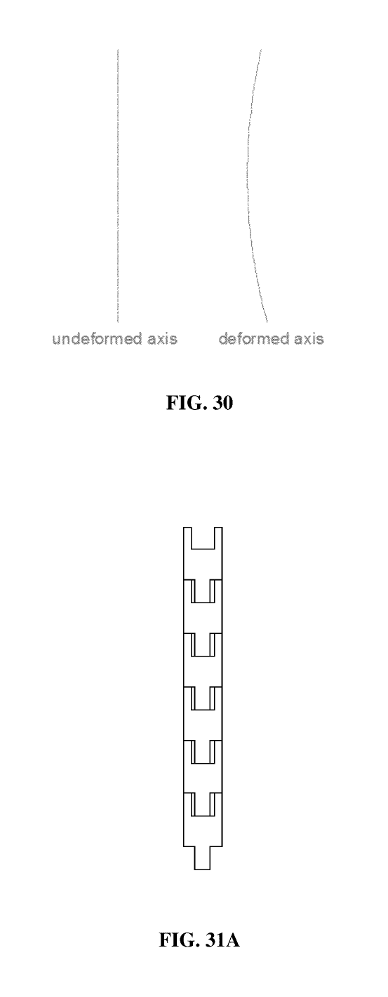

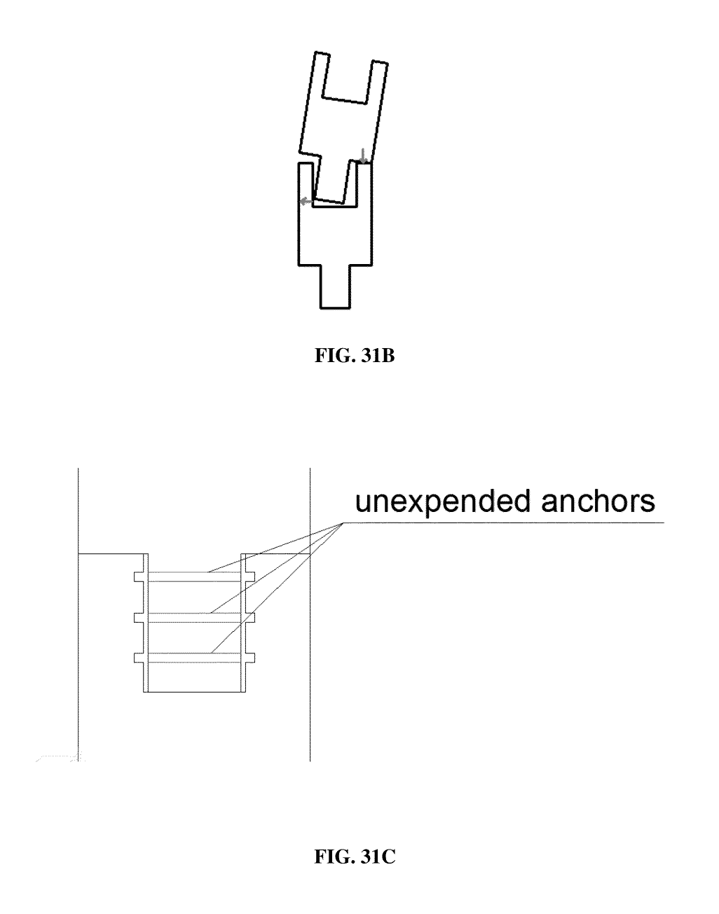

As buckling appear because of the deformation given by the extra bending moment that forms in the column, but because the column is made by multiple parts joined together, use of a system that prevent forming the deformed shape from the start will cancel that bending moment that cause problems as shown in FIG. 30. Columns made by bits are shown in FIG. 31A.

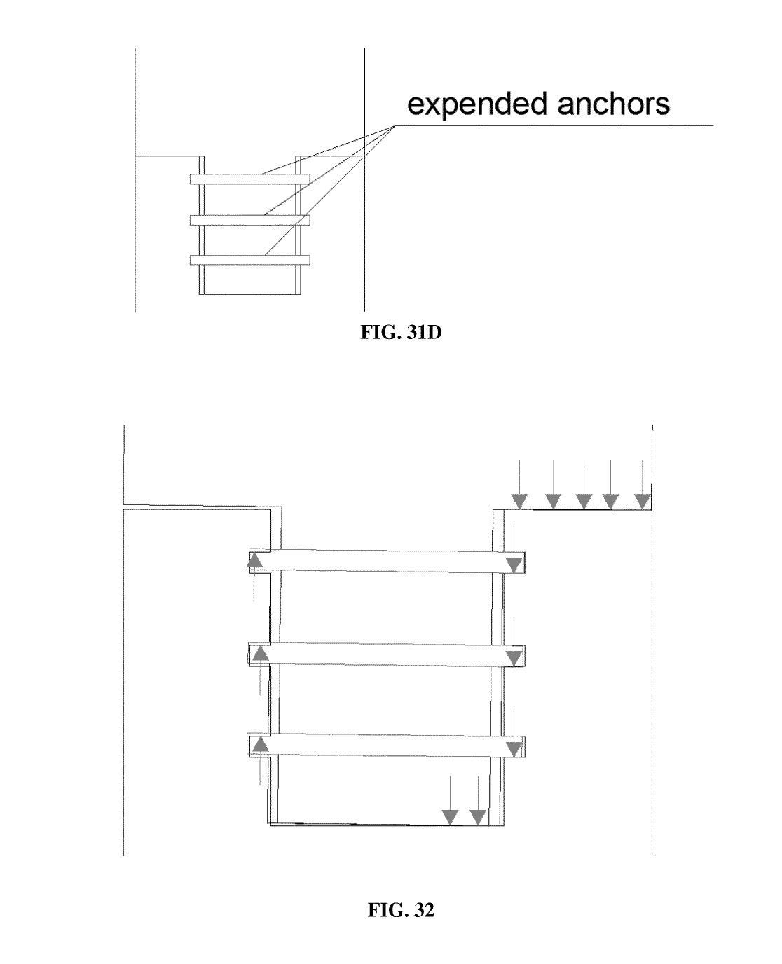

When the buckling appear (the deformed shape) in the connection between bit internal forces will appear, as shown in FIG. 31B. As seen in the figure, the forces that counter the bending moment (this internal forces) are concentrated on small area (points) and this force concentration will lead to structural failure (force concentration will involve very high stress that will produce material failure). One of the solution for this is to spread or distribute these internal forces on more area so that it will decrease the stress by the use of anchors that expend from the bit core in to the other bit notch as shown in FIG. 31C and FIG. 31D. A new force distribution in the joint between bits can carry a lot more forces that came from bending moment produced by buckling effect is shown in FIG. 32.

### Solution 2

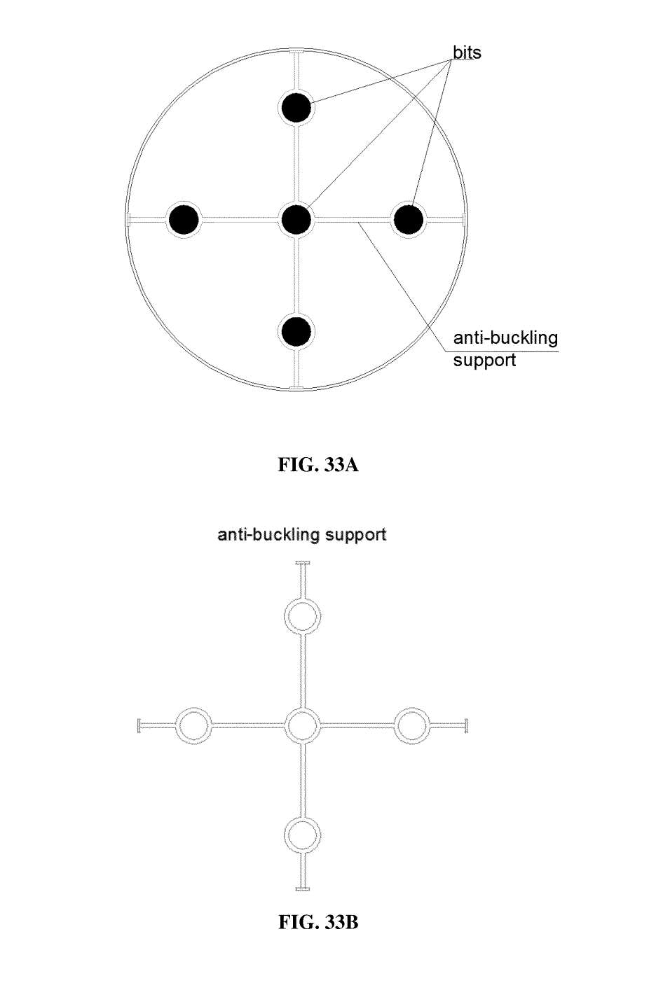

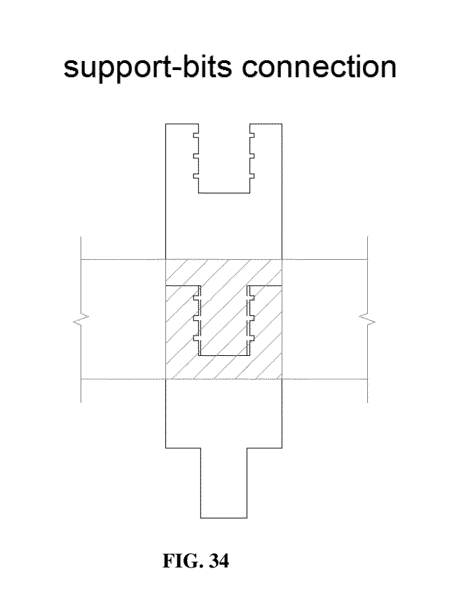

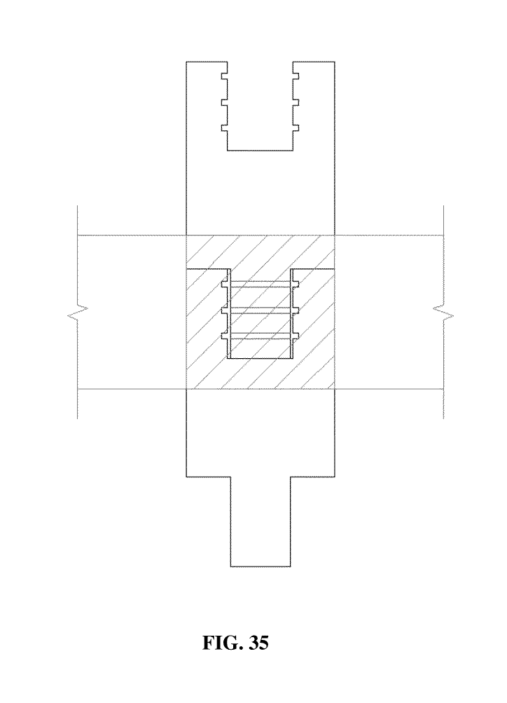

The extra lateral support provided by joining all the columns together and “weld” the support that joins them to the cones as shown in FIG. 33A and FIG. 33B. This “antibuckling supports” will be assembled on the height of the column having a step between them that will be the result of the buckling calculations. For example, there will be 20 supports with the height of 8000m=>the step between them will be 8000/20=400 m. Supporting bits connection is shown in FIG. 34. By combining solutions 1 and 2, as shown in FIG. 35, extra buckling stability can also be provided.

Using space elevators for deployment of space-related technologies would cost much less than rockets. The estimated cost of sending a pound of material into space using a rocket is about $10,000 and a mere $100 using a space elevator. In an embodiment, the Space elevator towers extends up to the lower earth orbit at about 99 miles or 160 kilometres into space. The space elevator, once extended, provides a launch pad that allows large and heavy space materials to extend into orbit without the need to carry millions of gallons of fuel.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A space elevator assembly, comprising:
(a) an inner shaft comprising a plurality of interlocking segments, wherein each interlocking segment comprises a combination of bits, vertically stackable on a plate to form a rigid structure;
(b) an outer shaft comprising a plurality of telescoping cones extendable synchronously with the inner shaft, to elevate a platform attached to an upper end of the shafts; and
(c) a drive system for extending the inner shaft by enabling stacking the plurality of interlocking segments.

2. The assembly of claim 1 further comprises a base frame structure consisting a plurality of stay cables for supporting the outer shaft in an extended position.

3. The assembly of claim 2, wherein the plurality of stay cables are winded on a stay cable support rail of the base frame structure in a retreated position.

4. The assembly of claim 3, wherein the stay cables are winded together as a single unit or each stay cable winded as an individual unit in the retreated position.

5. The assembly of claim 1, wherein the interlocking segments are winded on a spool in a retreated position and stacked to form a vertically rigid shaft in the extended position.

6. The assembly of claim 1, wherein each of the interlocking segment comprises a plurality of cylindrical bits stackable in different combinations on the plate.

7. The assembly of claim 1, wherein the telescoping cones are made of atmospheric drag resistant material.

8. The assembly of claim 1, wherein the drive system comprises an actuator driven by a controllable motor.

9. The assembly of claim 8, wherein the controllable motor comprises a diesel electric engine.

10. The assembly of claim 1, wherein the inner shaft comprises of Titanium alloy.

11. The assembly of claim 1 wherein, the height of each interlocking segment is equivalent to that of the each telescoping cone.
